(19) United States
(12) Patent Application Publication
(10) Pub. No.: US 2026/0171483 A1
(43) Pub. Date: Jun. 18, 2026

(54) Lithium Thiophosphate Halide Solid-State Electrolytes

(71) Applicants: Linda Faye NAZAR, Waterloo (CA); Erika P. RAMOS, Waterloo (CA)

(72) Inventors: Linda Faye NAZAR, Waterloo (CA); Erika P. RAMOS, Waterloo (CA)

(21) Appl. No.: 19/136,549

(22) PCT Filed: Dec. 7, 2023
(86) PCT No.: PCT/CA2023/051626

§ 371 Date: Jun. 6, 2025

Related U.S. Application Data
(60) Provisional application No. 63/475,693, filed on Dec. 7, 2022.

(51) Int. Cl. H01M 10/0562; C01D 15/04

(52) U.S. Cl. CPC H01M 10/0562; C01D 15/04; C01P 2002/72; C01P 2002/82; C01P 2006/40; H01M 2300/008

(57) ABSTRACT

A material for use as a solid-state electrolyte, the material comprising a lithium thiophosphate halide having the formula Li₄₊ₓP₁₋ₓSiₓS₄Z, where Z is a halide and/or a pseudohalide. In one aspect, Z is one or more of I⁻, Br⁻, [BH₄]⁻, [BF₄]⁻, [NH₂]⁻, or [N₃]⁻. In one aspect, 0.1<x<0.4. A method of making the material is provided. Solid electrolytes comprising the material are also provided.

### CROSS REFERENCE TO PRIOR APPLICATIONS

This application claims priority to U.S. Application No. 63/475,693, filed on Dec. 7, 2022. The entire contents of such prior application are incorporated herein by reference as if set forth in its entirety.

### FIELD OF THE DESCRIPTION

The present description relates to materials suitable for use as solid-state electrolytes. In particular, the description relates to improved lithium thiophosphate halide materials and solid-state electrolytes made therefrom.

### BACKGROUND

All-solid-state batteries (ASSBs) are considered to be a next generation of energy storage technology that promises low cost, high performance, and superior safety [1-3]. ASSBs are emerging alternatives to conventional liquid electrolyte batteries owing to potential benefits that include the possibility of higher energy densities, enablement of anode-less designs, a wider range of temperature operation, and improvement in battery safety.

Currently employed organic liquid electrolytes have various disadvantages including high flammability and risk of leakage [4,5]. Their replacement with safer, more reliable solid electrolytes (SEs) has the potential to simplify battery design, alleviate safety concerns, and provide superior energy density by the implementation of lithium-metal anode or anode-less designs [6-8]. Solid electrolytes with high ionic conductivities at room temperature (RT) (i.e., around 10⁻³-10⁻² S·cm⁻¹) play a crucial role in the development of ASSBs. Over the decades, significant progress has been achieved in ASSBs with new SEs that also optimize electrical and mechanical properties [9-11].

Among the possible inorganic SSEs, sulfide-based materials have been shown to be particularly promising as they exhibit a unique combination of characteristics critical to the design of crystalline superionic conductors [12-15]. These include ionic conductivities comparable to, or even beyond those, of liquid electrolytes owing to an often-high concentration of mobile ions, and low elastic modulus, on the order of 20-40 GPa, that contributes to form a close physical contact with the electrode materials, thereby improving cycling performance in ASSBs [16,17]. The higher polarizability of sulfide-based electrolytes compared to oxide SEs softens the interaction between the Li⁺ mobile ions and the anion framework, typically enhancing the mobility of the mobile species, thereby leading to high ionic conductivities such as in the range of 10⁻³ to 10⁻² S·cm⁻¹ [18]. Moreover, in contrast to oxide SEs, sulfide SEs can be processed and densified at low temperatures (<500° C.) [19, 20], which avoids some of the known issues associated with oxide SE processing. For example, the elevated temperatures 8 (e.g., 1100° C.) required for oxide processing results in Li loss due to vaporization of precursors and/or undesirable reactions between SEs and active materials during co-sintering of composite cathode electrodes [21,22]. Several outstanding thiophosphate-based SEs such as Li₁₀GeP₂S₁₂ (LGPS-type, with its derivatives: Sn, Si) [23-25], Li_{9.54}Si_{1.74}P_{1.44}S_{11.7}Cl_{0.3} [26], argyrodite-type phases Li₆PS₅X (X=Cl, Br) [27-30], and thio-LISICON phases e.g., Li₄₋ₓGe₁₋ₓPₓS₄ [31-33], and Li₇P₃S₁₁ [34,35], have reached suitable room temperature (RT) ionic conductivities (σⁱ) up to 10⁻³-10⁻² S·cm⁻¹.

Thiophosphate-iodides are considered particularly promising owing to the presumed benefits of the polarizable iodide and “soft” interphase formed with Li metal that comprises LiI, which has led to the discovery of promising conductive solid electrolytes in this class (e.g., xLi₂S-yP₂S₅-zLiI) with σᵢ>10⁻⁴ S·cm⁻¹ [27,36-40]. The addition of 45 mol % LiI to 2Li₂S·P₂S₅ glass was found to improve the RT conductivity from 10⁻⁴ S·cm⁻¹ to 10⁻³ S·cm⁻¹ [36]. Tatsumisago et al. also reported that 80 (0.7Li₂S·0.3P₂S₅)·20LiI glass exhibits a surprisingly wide electrochemical window [41]. Ball-milled argyrodite-type Li₆PS₅I exhibits an ionic conductivity of 2.2×10⁻⁴ S·cm⁻¹, while its crystalline counterpart shows a lower conductivity of 4.6×10⁻⁷ S·cm⁻¹, which is understood to be related to its fully ordered anion framework (S²⁻/I⁻) [42]. Li₇P₂S₈I prepared by a solvent-based synthesis (Li₃PS₄·2CH₃CN) was claimed to demonstrate electrochemical stability up to high voltage, and an ionic conductivity of 6.3×10⁻⁴ S·cm⁻¹; however, its crystal structure was not resolved [37].

Li₄PS₄I is one solid-state electrolyte material that has been predicted to exhibit high ionic conductivity; however, this has proven to be challenging to achieve. Li₄PS₄I was discovered utilizing a solvent-based synthesis approach using Li₃PS₄·C₄H₁₀O₂ as a precursor. The material was reported to have a “layered-type” Li₄PS₄ framework with a disordered Li sub-lattice (P4/nmm; Z=2), offering an ideal three-dimensional (3D) diffusion network for the lithium ions. Nonetheless, the material exhibited rather low Li-ion conductivity ranging between 6.4×10⁻⁵ and 1.2×10⁻⁴ S·cm⁻¹ [38]. Subsequent first-principles calculations-using a structural model that accounted for the partial Li occupancies determined by diffraction-showed that Li₄PS₄I should exhibit low diffusion barriers to migration and high Li-ion diffusion coefficients, and furthermore predicted a surprisingly high ionic conductivity of 2.3×10⁻¹ S·cm⁻¹ at 300 K [43]. The discrepancy of more than a factor of 1000 vs the experimental conductivity was attributed to the presence of impurities, secondary phases and contribution from grain boundaries. Subsequently, the ball milling assisted amorphization of a mixture of Li₂S, P₂S₅ and LiI, stoichiometrically equivalent to Li₄PS₄I (1.5Li₂S-0.5P₂S₅—LiI), resulted in an improvement of the RT ionic conductivity up to ˜1.3 mS·cm⁻¹, which was negatively affected by the presence of small amounts of crystalline Li₄PS₄I or impurities in the Li₄PS₄I mixture [44]. These results were later confirmed by investigating the synthesis of Li₄PS₄I using three different methods, namely, wet chemical, solid-state and hot-press synthesis. The results confirmed that (partially) amorphous Li₄PS₄I shows orders of magnitude higher ionic conductivity than its crystalline counterpart. More importantly, the findings emphasized the relevant effects that the synthesis route, temperature and pressure have on the crystallization behavior of Li₄PS₄I and its ion-transport properties [45].

The chemical stability of Li₄PS₄I in ambient atmosphere has also been investigated; the suppression of hydrolysis after 1 h of exposure was attributed to the formation of LiI·H₂O, acting as a protective barrier that helps prevent the direct contact between the PS₄³⁻ units in the bulk electrolyte with the H₂O molecules in air [46]. A recent revisitation of the synthesis and structure of Li₄PS₄I prepared by a conventional solid state route yielded essentially the same structural model (P4/nmm; Z=2), with disordered Li occupancy but confirmed an even lower ionic conductivity of 0.02 mS·cm⁻¹ and activation energy (Eₐ) of 0.45 eV [47]. While this was partially attributed to about 15 wt % Li₆PS₅I impurity, the authors concluded that Li₄PS₄I is intrinsically a poor conductor despite its apparent 3D Li-ion percolation network.

There exists a need for an improved solid-state electrolyte material that addresses at least one of the deficiencies known in the art.

### SUMMARY OF THE DESCRIPTION

In one aspect, there is provided a material having the formula Li₄₊ₓP₁₋ₓSiₓS₄Z for use as a solid electrolyte, where Z is a halide and/or a pseudohalide.

In another aspect, there is provided a method of producing a material for use as a solid electrolyte, the material having the formula Li₄₊ₓP₁₋ₓSiₓS₄Z, where Z is a halide and/or a pseudohalide, the method comprising the steps of: a) forming a mixture by combining stoichiometric amounts of Li₂S, LiZ, P₂S₅, and Si powders; b) grinding the mixture; and c) heating the ground mixture. In one aspect, the method further comprises cooling the heated mixture.

In one aspect, Z is one or more of: I⁻, Br⁻, [BH₄]⁻, [BF₄]⁻, [NH₂]⁻, and [N₃]⁻. Preferably, Z is one or more of I⁻, Br⁻, and [BH₄]⁻. More preferably, Z is I⁻.

In one aspect, 0.1<x<0.4. In another aspect, 0.12≤x≤0.3. In another aspect, x is 0.12 or 0.30.

In another aspect, there is provided a solid-state electrolyte comprising the material described herein.

### BRIEF DESCRIPTION OF THE FIGURES

The features of certain embodiments will become more apparent in the following detailed description in which reference is made to the appended figures wherein:

FIG. 1 illustrates the Li-sublattice disorder achieved by the present description.

FIG. 2a is view of the structure of material Li_{4.3}P_{0.7}Si_{0.3}S₄I, as described herein.

FIG. 2b illustrates the environment of the Li(1), Li(2), Li(3) (split site), and Li(4) sites in Li_{4.3}P_{0.7}Si_{0.3}S₄I.

FIG. 3a and FIG. 3b are reciprocal-space precession images of (0kl) reflections calculated using a resolution of 0.71 Å and a thickness of 0.1 for: (a) Li₄PS₄I, where the supercell reflections are highlighted as dotted circles; and b) Li_{4.3}P_{0.7}Si_{0.3}S₄I. The reciprocal unit cells are highlighted in white.

FIG. 4a and FIG. 4b illustrate the time-of-flight neutron diffraction patterns and the corresponding Rietveld refinement fits. FIG. 4a shows the result for Li_{4.3}P_{0.7}Si_{0.3}S₄I, where green vertical ticks correspond to Li_{4.3}P_{0.7}Si_{0.3}S₄I Bragg reflections. The unknown peaks labeled with black diamonds were excluded for the refinement. FIG. 4b shows the results for Li₄PS₄I, where olive vertical ticks correspond to Li₄PS₄I. The black circles correspond to the data points, the red line denotes the calculated pattern, and the difference map is shown in blue.

FIG. 5a and FIG. 5b illustrate crystal structures along the [100] direction of Li₄PS₄I (FIG. 5a) and Li_{4.3}P_{0.7}Si_{0.3}S₄I (FIG. 5b) showing the doubling of the c axis of Li₄PS₄I.

FIG. 6a illustrates room temperature Nyquist impedance plot of x=0, 0.12, and 0.30 with the respective equivalent circuit used to fit the data shown in Table 17. The inset shows the impedance plot for x=0.12 and 0.30.

FIG. 6b illustrates room temperature ionic conductivity and activation energy as a function of composition Li₄₊ₓP₁₋ₓSiₓS₄I, with x=0, 0.12, and 0.30.

FIGS. 7a to 7c are BVSE maps showing Li-ion diffusion pathways in Li_{4.3}P_{0.7}Si_{0.3}S₄I viewed along the [001] direction (FIG. 7a), down the [100] direction (FIG. 7b), and down the [010] direction (FIG. 7c).

FIGS. 8a to 8d show the AIMD simulation results of Li ion diffusion in Li₄₊ₓP₁₋ₓSiₓS₄I, with x=0 and 0.25. FIG. 8a shows atomic models for the ordered Li₄PS₄I (left) and the disordered Li_{4.25}P_{0.75}Si_{0.25}S₄I (right). Li atoms in the disordered model are not shown for clarity. FIG. 8b shows an Arrhenius plot of the Li ion diffusivity. Diffusion coefficients D are shown with activation energies Eₐ. The error bars represent one standard deviation of five samples. Probability densities of Li ion occupancy during the simulations at 600 K are shown in FIG. 8c for Li₄PS₄I (LPSI) and FIG. 8d for Li_{4.25}P_{0.75}Si_{0.25}S₄I (Si-LPSI). The densities colored in gray or green are plotted at an isosurface level of f or 0.05f (arbitrary unit), respectively.

FIG. 9 is a Raman spectra of Li_{4.3}P_{0.7}Si_{0.3}S₄I.

FIG. 10 shows simulated PND patterns of the parent phase Li₄PS₄I and Si-doped phase Li_{4.3}P_{0.7}Si_{0.3}S₄I. The patterns were obtaining in PowerCell™ software using the crystal 2 structure information obtained from single crystal XRD.

FIGS. 11a and 11b show expanded views of the time-of-flight neutron diffraction patterns and the corresponding Rietveld refinement fits of: (a) Li_{4.3}P_{0.7}Si_{0.3}S₄I, green vertical ticks correspond to Li_{4.3}P_{0.7}Si_{0.3}S₄I Bragg reflections. The unknown peaks are labeled with black diamonds; and (b) Li₄PS₄I, olive vertical ticks correspond to Li₄PS₄I. The black circles correspond to the data points, the red line denotes the calculated pattern, and the difference map is shown in blue.

FIGS. 12a and 12b show time-of-flight (TOF) neutron diffraction patterns and the corresponding Rietveld refinement fits of: (a) Li₄PS₄I with refined SOFs of all Li sites of the ordered crystal structure model (Table 15), green vertical ticks correspond to Li₄PS₄I Bragg reflections; b) Li₄PS₄I with refined SOFs of all Li sites of the disordered crystal structure model (Table 16), olive vertical ticks correspond to Li₄PS₄I. The black circles correspond to the data points, the red line denotes the calculated pattern, and the difference map is shown in blue.

FIGS. 13a to 13c show powder X-ray diffraction patterns and Rietveld refinement fits of: (a) Li₄PS₄I, olive vertical ticks correspond to Li₄PS₄I Bragg reflections; b) Li_{4.12}P_{0.88}Si_{0.12}S₄I, purple vertical ticks correspond to LiI (2.32 wt %), blue vertical ticks correspond to Li₂S (1.47 wt %), and orange vertical ticks correspond to Li_{4.12}P_{0.88}Si_{0.12}S₄I Bragg reflections; c) Li_{4.3}P_{0.7}Si_{0.3}S₄I, purple vertical ticks correspond to LiI (3.8 wt %), blue vertical ticks correspond to Li₂S (4.29 wt %), and green vertical ticks correspond to Li_{4.3}P_{0.7}Si_{0.3}S₄I Bragg reflections. The black circles correspond to the data points, the red line denotes the calculated pattern, and the difference map is shown in blue.

FIG. 14 shows time-of-flight neutron diffraction pattern and the corresponding Rietveld refinement fit of Li_{4.3}P_{0.7}Si_{0.3}S₄I using the previously reported crystal structure model of the Li₄PS₄I (P4/nmm; Z=2) phase comprising five Li sites. 1 Green vertical ticks correspond to Li_{4.3}P_{0.7}Si_{0.3}S₄I Bragg reflections, the black circles correspond to the data points, the red line denotes the calculated pattern, and the difference map is shown in blue.

FIG. 15 shows time-of-flight neutron diffraction pattern and the corresponding Rietveld refinement fit of Li_{4.3}P_{0.7}Si_{0.3}S₄I using our obtained ordered crystal structure model of the Li4PS4I (P4/nmm; Z=4) phase, including five Li sites. Green vertical ticks correspond to Li_{4.3}P_{0.7}Si_{0.3}S₄I Bragg reflections, the black circles correspond to the data points, the red line denotes the calculated pattern, and the difference map is shown in blue.

FIG. 16 shows the Li+ vacancy concentration and Li content concentration as a function of Si content in Li₄₊ₓP₁₋ₓSiₓS₄I.

FIGS. 17a and 17b show: (a) XRD pattern of the targeted composition, Li_{4.4}P_{0.6}Si_{0.4}S₄I. The formation of Li₄SiS₄ as Si content increases to from 0.30 f.u. to 0.4 f.u. is observed. Olive vertical ticks correspond to Li_{4.3}P_{0.7}Si_{0.3}S₄I Bragg reflections, pink vertical ticks correspond to LiI, and blue vertical ticks correspond to Li₂S; and b) Room temperature Nyquist impedance plot of x=0.40 with the respective equivalent circuit used to fit the data shown in Table 19.

FIGS. 18a to 18c are Arrhenius plots and the room temperature Nyquist impedance plots with the respective equivalent circuit of: (a) Li₄PS₄I from 30° C. to 60° C.; (b) Li_{4.12}P_{0.88}Si_{0.12}S₄I from 30° C. to 65° C.; and (c) Li_{4.3}P_{0.7}Si_{0.3}S₄I from 30° C. to 65° C.

FIGS. 19a to 19d show DC polarization curves for electronic conductivity determination with an applied voltage of 0.25 (orange), 0.50 (purple) and 0.75 V (grey) and the linear fit of the voltage vs current of: a-b) Li₄PS₄I, respectively; and c-d) Li_{4.3}P_{0.7}Si_{0.3}S₄I.

FIGS. 20a to 20c illustrate negative nuclear density distribution of Li ions in Li_{4.3}P_{0.7}Si_{0.3}S₄I calculated using MEM along: a) [001]; b) [100]; and c) [010].

FIGS. 21a and 21b show mean square displacement (MSD) of Li ions in Li₄PS₄I (FIG. 21a) and Li_{4.25}P_{0.75}Si_{0.25}S₄I (FIG. 21b) during AIMD simulation on 5 samples at 600 K. In the case of Li₄PS₄I, MSD along the c-axis (blue lines) is lower than the other two directions along a and b-axes (red and green curves, respectively), but higher for Li_{4.25}P_{0.75}Si_{0.25}S₄I.

FIG. 22 shows AIMD simulation results of Li ion diffusion in Li₄₊ₓP₁₋ₓSiₓS₄I with x=0 and 0.25. Probability densities of Li ion occupancy during the simulations at 600 K for Li₄PS₄I (LPSI); Li_{4.25}P_{0.75}Si_{0.25}S₄I (Si-LPSI) are also shown. The densities colored in gray or green are plotted at an isosurface level of f or 0.05f (arbitrary units), respectively.

FIG. 23 shows plots of distinct-part of the van Hove correlation function for Li at different temperatures a) 600 K and b) 1000 K for Li_{4.25}P_{0.75}Si_{0.25}S₄I (Si-LPSI).

### DETAILED DESCRIPTION

As used herein, the terms “comprise”, “comprises”, “comprised” or “comprising” may be used in the present description. As used herein (including the specification and/or the claims), and unless stated otherwise, these terms are to be interpreted as open-ended terms and as specifying the presence of the stated features, integers, steps or components, but not as precluding the presence of one or more other feature, integer, step, component or a group thereof as would be apparent to persons having ordinary skill in the relevant art. Thus, the term “comprising” as used in this specification means “consisting at least in part of”. When interpreting statements in this specification that include that term, the features, prefaced by that term in each statement, all need to be present but other features can also be present. Related terms such as “comprise” and “comprised” are to be interpreted in the same manner.

The phrase “consisting essentially of” or “consists essentially of” will be understood as generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open-ended term, such as “comprising” or “including”, it will be understood that direct support should be afforded also to “consisting essentially of” language as well as “consisting of” language as if stated explicitly and vice versa. In essence, use of one of these terms in the specification provides support for all of the others.

For the purposes of the present description and/or claims, and unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth herein are approximations that may vary depending upon the desired properties sought to be obtained by the present invention, inclusive of the stated value and has the meaning including the degree of error associated with measurement of the particular quantity. The term “about” generally refers to a range of numbers that one of ordinary skill in the art would consider as a reasonable amount of deviation to the recited numeric values (i.e., having the equivalent function or result). For example, this term “about” can be construed as including a deviation of ±10 percent of the given numeric value provided such a deviation does not alter the end function or result of the value. Therefore, a value of about 1% can be construed to be a range from 0.9% to 1.1%.

The term “and/or” can mean “and” or “or”.

Unless stated otherwise herein, the articles “a” and “the”, when used to identify an element, are not intended to constitute a limitation of just one and will, instead, be understood to mean “at least one” or “one or more”.

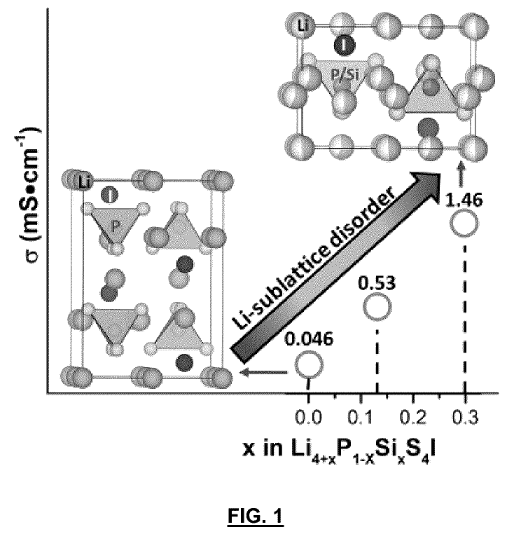

As described further herein, the present description provides a novel material for use in manufacturing solid-state electrolytes and method for making such material. In particular, the present description relates to improved lithium thiophosphate halide materials and to the surprising effects identified by the inventors upon inducing Li-sublattice disorder in the subject material. In particular, and as illustrated in FIG. 1, the present description demonstrates, in one aspect, the remarkable effects of aliovalent substitution in Li₄PS₄I to result in Li₄₊ₓP₁₋ₓSiₓS₄I. As discussed further below, such effects were identified using a combination of single-crystal X-ray and powder neutron diffraction; Raman and impedance spectroscopy; ab initio molecular dynamics simulations; and the bond valence site energy method. As also discussed below, the value for x preferably meets the following condition: 0.1<x<0.4. Thus, for example, x may be 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, or 0.39. For example, in one aspect 0.12≤x≤0.3. In another aspect, x may be 0.12 or 0.30.

As described herein, the inventors found that, by modifying Li₄PS₄I to result in increased Si⁴⁺ and Li⁺ content, such as in Li₄₊ₓP₁₋ₓSiₓS₄I, configurational disorder of the Li sub-lattice is induced, leading to isotropic 3D-fast Li-ion conduction of, for example, 1.46 mS·cm⁻¹ at room temperature for the Li_{4.3}P_{0.7}Si_{0.3}S₄ composition and a low activation energy of 0.32 eV. The unit cell volume was found to be half that of the parent phase, Li₄PS₄I, which exhibits a fully ordered Li substructure, which explains the latter's poor conductivity and high activation energy (0.046 mS·cm⁻¹ and 0.44 eV, respectively). The present description demonstrates that the deliberate creation of Li sub-lattice disorder (via Li-ion “stuffing”) results in an improved material for use as a sold electrolyte and is, therefore, a pivotal step in the development of new, fast ion conductors.

The present description details the synthesis, structure, and properties of the subject aliovalent substituted analogue, Li₄₊ₓP₁₋ₓSiₓS₄I, where introduction of Si⁴⁺ and Li⁺ into the structure indeed induces very significant Li-site disorder, leading to a high experimental ion conductivity and a low activation energy for Li-ion diffusion. On the other hand, analysis of our single-crystal and neutron diffraction data unequivocally shows a unit cell for Li₄PS₄I that is doubled (P4/nmm; Z=4) with respect to that previously reported (P4/nmm; Z=2) with a Li sub-lattice that is fully ordered. This explains the latter's poor ionic conductivity and high activation energy (0.046(6) mS·cm⁻¹ and 0.44 eV). On the other hand, one of the optimally substituted materials described herein, Li_{4.3}P_{0.7}Si_{0.3}S₄I, exhibits a room temperature ionic conductivity of 1.46(2) mS·cm⁻¹ and an energy barrier for Li transport of 0.32 eV as determined by electrochemical impedance spectroscopy (EIS). The diffraction data illustrated the existence of a high concentration of lithium vacancies (˜46%) with a unit cell half that of the parent (P4/nmm; Z=2), and Raman spectroscopy confirmed the Si⁺⁴ substitution of P⁺⁵ in the 2a site in Li₄₊ₓP₁₋ₓSiₓS₄I. This work illustrates the promising approach of creating highly disordered Li sub-lattices via Li-ion “stuffing” as a strategy to enhance ionic conductivity.

In the above description, reference is made to the subject material being a lithium thiophosphate halide. It will, however, be understood that the halide component may comprise a pseudohalide. This would be known to persons skilled in the art at least in view of the disclosure by Sakuda et al. [66]. Thus, although the present description refers to materials comprising an iodide (I⁻) ion, other halogen ions or pseudohalogen ions may also be used, as would be known in the art. For example, in one aspect, the iodide ion may be substituted with a bromide (Br⁻) ion. In another aspect, the iodide ion described herein may be substituted with a pseudohalide, such as [BH₄]⁻. In another aspect, the pseudohalide may comprise [BF₄]⁻, [NH₂]⁻, or [N₃]⁻. In another aspect, the halide component referred to herein may comprise one or more halides and pseudohalides. In other words, the description contemplates the halide referred to herein to comprise a mixture of one or more halides and/or pseudohalides, such as the species mentioned above.

### Experimental Methods

Synthesis of Li₄₊ₓP₁₋ₓSiₓS₄I (x=0, 0.12, 0.30, and 0.40)

Li₄₊ₓP₁₋ₓSiₓS₄I (where x=0, 0.12, 0.30, and 0.40) compositions were synthesized by solid state reactions. Li₂S (99%, Sigma-Aldrich), LiI (99%, Sigma-Aldrich), P₂S₅ (99%, Sigma-Aldrich), and Si powder (99%, Sigma-Aldrich) were mixed at the target molar ratio and ground together in an agate mortar. The mixtures were loaded into glassy carbon crucibles, which were then vacuum sealed in quartz tubes. The mixtures were heated to 700° C. with a heating rate of 60° C. per hour, held for 5 hours, and slow cooled (1° C. per hour) to 620-600° C. The samples were then ice quenched to room temperature. For single crystal studies, powder XRD, and electrochemical impedance spectroscopy measurements, 0.5 g of each—almost-pure phase composition as shown by powder XRD (PXRD)—was synthesized and suitable crystals were chosen for single-crystal X-ray diffraction. In the much larger (>2 g batch) of Si-substituted material prepared for neutron diffraction measurements, the scale-up procedure created a small fraction of an impurity phase.

### Single-Crystal X-Ray Diffraction

Colourless, block-shaped single crystals of a) Li_{4.12}P_{0.88}Si_{0.12}S₄I, with dimensions 0.160×0.060×0.010 mm³; b) Li_{4.30}P_{0.70}Si_{0.30}S₄I with dimensions 0.050×0.040×0.020 mm³; and c) Li₄PS₄I with dimensions of 0.180×0.070×0.010 mm³ were used for crystal structure determination. The X-ray single diffraction data were collected at 280 K using a Bruker KAPPA™ diffractometer equipped with an APEX™ II CCD detector and graphite-monochromated Mo-Kα radiation. The single crystals were mounted on glass fibers, protected by Paratone®-N oil and a nitrogen flow using Oxford Cryostream™ controller 700 at 280 K. The data were collected by scanning ω and φ in increments of 0.3° in groups of frames (30 seconds per frame) for the complete dataset using the Bruker APEX™ II suite strategy. After indexing the unit cell, the data were corrected for Lorentz and polarization effects and a multi-scan absorption correction was applied using SADABS in the Bruker APEX™ II suite. The structure was solved using direct methods and refined by least-squares fitting incorporated in the SHELXTL™ package [48]. All the atoms were anisotropically refined and the Li sites were freely refined. The structural model converged to a residual factor of 0.0094 and residual electron density of 0.405 and −0.229 e.Å⁻³ for Li_{4.12}P_{0.88}Si_{0.12}S₄I; a residual factor of 0.0259 and residual electron density of 0.878 and −0.360 e.Å⁻³ for Li_{4.30}P_{0.70}Si_{0.30}S₄I; and a residual factor of 0.0132 and residual electron density of 0.308 and −0.379 e.Å⁻³ for Li₄PS₄I.

### Powder X-Ray and Neutron Diffraction

PXRD measurements of Li₄₊ₓP₁₋ₓSiₓS₄I for x=0, 0.12, 0.30, and 0.40 were carried out with a PANalytical™ Empyrean instrument (Cu-Kα radiation) outfitted with a PIXcel™ bidimensional detector in Debye-Scherrer geometry using a parabolic X-ray mirror in the incident beam. The sample powder was loaded in a 0.3 mm diameter capillary in an argon-filled glovebox. The time-of-flight powder neutron diffraction (TOF-PND) pattern of Li_{4.3}P_{0.7}Si_{0.3}S₄I and Li₄PS₄I were collected on POWGEN at the Spallation Neutron Source (SNS) at the Oak Ridge National Laboratory. The samples (approximately 1.5 g each) were loaded into vanadium cans under an argon atmosphere and metal-sealed with copper gaskets and aluminum lids. The diffraction patterns were measured at 300 K. Rietveld refinements of the data including scale factor, Chebyshev background, peak shape, lattice parameters, atomic positions, occupancies, and atomic displacement parameters (ADPs) were simultaneously refined using the software package TOPAS™ 6 (Bruker-AXS).

### Raman Spectroscopy

In a glove box, Li_{4.3}P_{0.7}Si_{0.3}S₄I was placed on a microscope slide, covered by a glass coverslip, and sealed with epoxy. Raman spectra were obtained using a 514 nm laser (Raman HORIBA HR800™).

### Bond Valence Site Energy Calculations

Bond valence site energy (BVSE) calculations were performed utilizing the SoftBV™ program with the bond valence parameter set developed by Stefan Adams [49,50]. The structural model obtained by single-crystal diffraction was used as input, thereby the BVSE modelling was applied to the average structure model. Li-ion diffusion pathways are identified with the regions of low bond valence site energy for a dense grid of points with a resolution of 0.1 Å covering the crystal structure, using the transferable Morse-type softBV™ forcefield. The BVSE maps were obtained with an isosurface level of 0.56 eV above global minimum.

### Maximum-Entropy Method (MEM) Calculations

MEM calculations were performed utilizing Dysnomia™ [51], to visualize the Li nuclear density and provide possible Li-ion diffusion pathways in Li_{4.3}P_{0.7}Si_{0.3}S₄I. Since only lithium possesses a negative scattering length in Li_{4.3}P_{0.7}Si_{0.3}S₄I (bLi=−1.9 fm), the nuclear density map is limited to the negative part only. An iso-surface level of −0.0045 fm·Å⁻³ was used for the reconstruction of the 3D nuclear density maps.

### Density Functional Theory (DFT) Calculations and Ab Initio Molecular Dynamics (AIMD) Simulations

Ab-initio molecular dynamic (AIMD) simulations were performed within the framework of density functional theory (DFT) [52,53] using the Vienna Ab Initio Simulation Package (VASP) [51,54]. Projector-augmented wave (PAW) pseudopotentials were used to replace the all-electron ion potentials with standard Perdew-Burke-Ernzerhof (PBE) type exchange-correlation approximation [55,56]. The energy cutoff for the plane-wave basis and k-point sampling of the Brillouin zone were carefully tested to ensure numerical convergency of the results. The AIMD simulations were performed in NVT ensemble using a Nosé-Hoover thermostat [57]. For each composition and atomic configuration, five independent runs were carried out for better statistics. The structures were initially equilibrated at 1000 K for 10 ps after static DFT calculations and quenched to target temperatures (600 K, 700 K, 800 K, 900 K, 1000 K) at a rate of 10 K/1 ps. Each model was equilibrated at the targeted temperature for 10 ps before the atomic trajectories were recorded for 40 ps with a timestep of 1 fs for each of the five runs. The Li diffusion coefficient D was extracted from these trajectories via the equation, D=½ dt (Δr(t)²), where d is the dimensionality factor and (Δr(t)²) is the average mean square displacement of ions over time t.

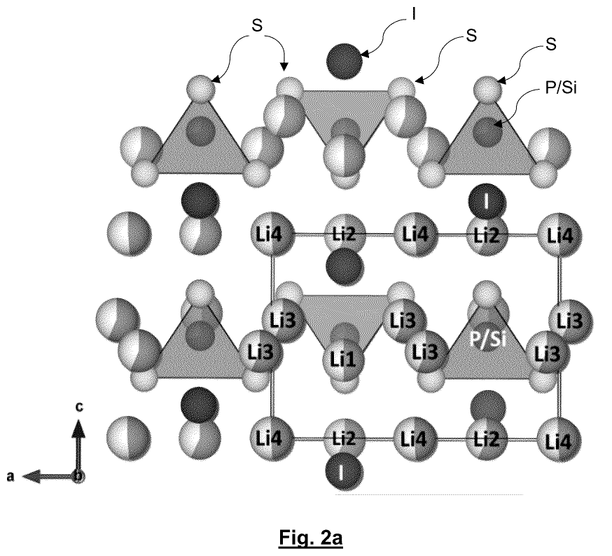

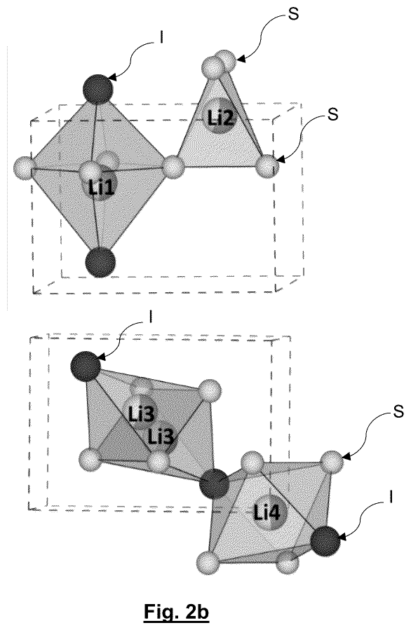

The initial structural model of Li₄PS₄I (LPSI) was constructed using a 2×2×2 supercell, containing 128 Li atoms located at the fully ordered Li sub-lattice as shown in FIG. 2a. For Si substituted LPSI, i.e. the Li₄₊ₓP₁₋ₓSiₓS₄I system (Si-LPSI), the initial structure model was sampled by “random” distribution of Si at the P sites, meaning a special quasi-random structure (SQS) that mimics, as close as possible, the perfect random atomic arrangement of Si in periodic simulation cells, using the Alloy Theoretic Automated Toolkit software package at x=0.25 with Li content adjusted accordingly to maintain charge neutrality [58]. Both structure models were fully relaxed, where volume expansion is observed for Si-LPSI (875 Å³ vs. 856 Å³ for LPSI), before performing the AIMD simulations with constant volume.

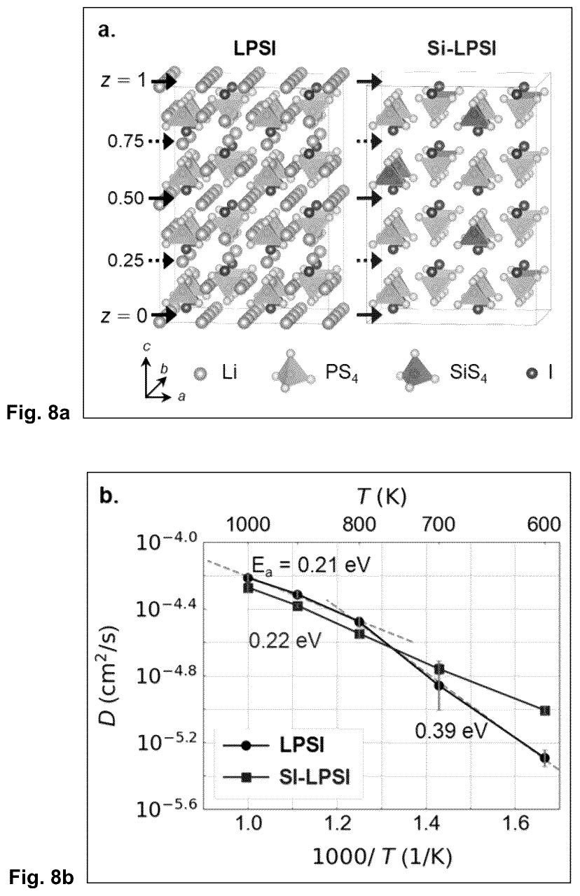

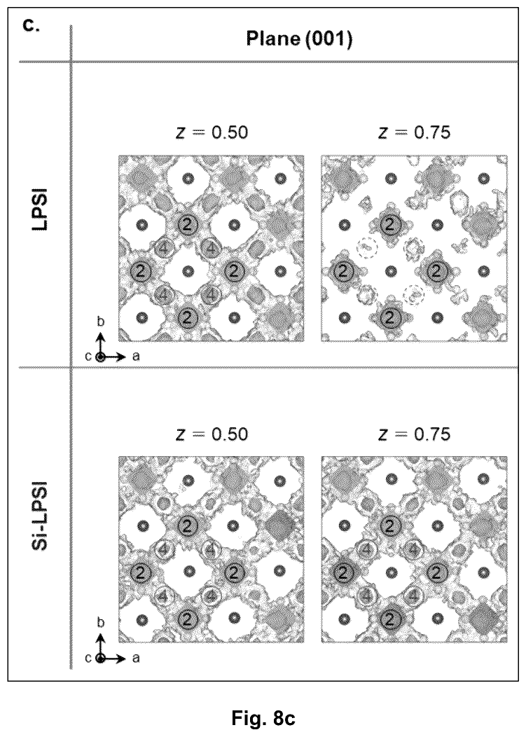

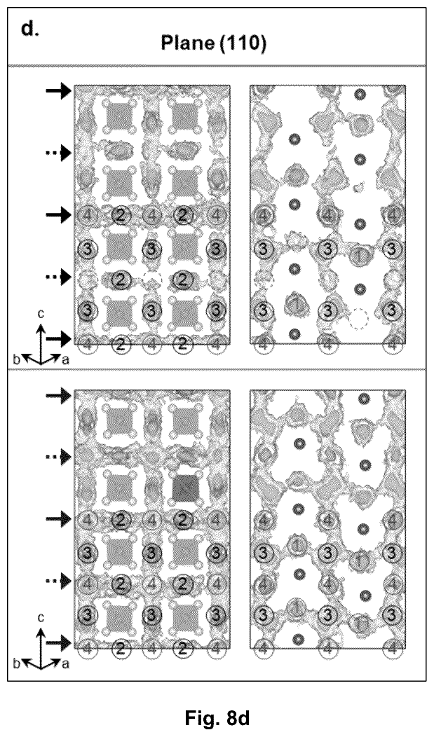

The densities shown in FIGS. 8c and 8d are the probabilities of finding Li ion at specific locations. In the case of LPSI, during the AIMD simulations 128 Li ions move between available sites in the simulation cell of 16.97 Å×16.97 Å×23.80 Å during the 40 ps simulation time. We divided the cell into 68×68×96 bins (cubic with side length of ˜0.25 Å), and for each bin we counted how many times Li-ion visited. The relative frequencies between bins are calculated and displayed in FIGS. 8c and 8d as probability densities of Li occupancy.

### Conductivity Measurements

impedance measurements were performed using an MTZ-35 impedance analyzer (Bio-Logic) with a custom-made Swagelok™ cell; Li₄₊ₓP₁₋ₓSiₓS₄I (x=0, 0.12, 0.30, and 0.40) powders were cold pressed into a pellet, placed between two 10 mm diameter stainless steel rods, and measured at 2 metric tons pressure over frequencies ranging from 100 MHz to 100 mHz. The bulk and grain boundary contributions could not be deconvoluted, leading to one semicircle in the impedance spectra of all samples. Therefore, the conductivities reported correspond to the overall total conductivity. The temperature dependent ion conductivity measurements of Li₄₊ₓP₁₋ₓSiₓS₄I (x=0, 0.12, and 0.30) were performed using the same custom-made Swagelok™ cell. The powders were pelletized at 2 metric tons pressure, placed between two indium foils and pressed at a lower pressure, ˜0.5 metric tons, to avoid indium being forced into the pellet and causing a short circuit. Data were collected every 5° C. over a temperature range of 30° C.-60° C. and over frequencies ranging from 35 MHz to 0.3 Hz. The typical relative density of the cold-pressed Li_{4.3}P_{0.7}Si_{0.3}S₄I pellets exceeded 90% of theoretical, which was measured using the geometry of the pellets. DC polarization measurements Li₄P₁S₄I and Li_{4.3}P_{0.7}Si_{0.3}S₄I were performed by placing pellets between two SS rods of 10 mm diameter and pressing them at 2 metric tons. Applied voltages of 0.25, 0.50, 0.75 V for 30 min each were used. All the EIS and DC polarization measurements were carried out using the samples prepared for powder and single crystal X-ray diffraction, namely on batches of about 0.5 g.

### Results and Discussion

### Structural Characterization

The synthesis procedure was initially designed to favor single-crystal growth of Li₄₊ₓP₁₋ₓSiₓS₄I (see Methods). Based on single-crystal XRD studies conducted on multiple samples for each composition to ensure reproducibility, we find that Li₄₊ₓP₁₋ₓSiₓS₄I, particularly where x=0.12 and 0.30, adopts a structure with a primitive tetragonal unit cell with space group P4/nmm, No. 129, Z=2 (x=0.12, refined lattice parameters: a=b=8.4813(6) Å, c=5.927(4) Å, and V=426.34(7); x=0.30, a=b=8.5090(7) Å, c=5.9473(5) Å, and V=430.6(1) Å³).

For convenience, Tables 1-20 summarizing the data obtained from the current investigation are provided at the end of this description.

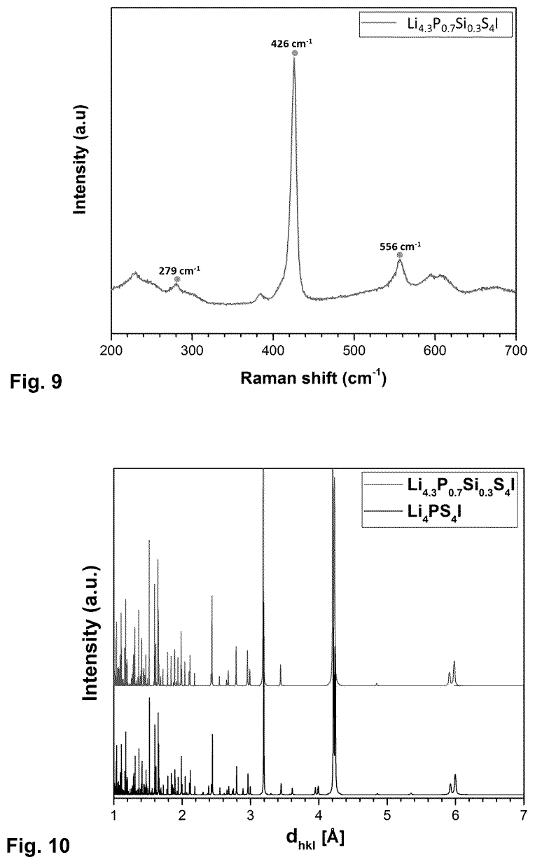

Table 1 displays the structural data for x=0.30, while Tables 3-8 list that data for x=0.12 (Table 4) along with other crystallographic information for both compositions such as bond distances and anisotropic displacement parameters. The Li content refined to 4.14(13) for x=0.12 and 4.31(24) for x=0.30, indicating compositions of Li_{4.14}P_{0.86}Si_{0.14}S₄I and Li_{4.3}P_{0.7}Si_{0.3}S₄I, respectively, was very close to the targeted stoichiometries. A view of the Li_{4.3}P_{0.7}Si_{0.3}S₄I crystal structure (identified for simplicity as Li_{4.3}P_{0.7}Si_{0.3}S₄I) along the [010] direction is shown in FIG. 1a. The Raman spectrum of this material (FIG. 9) shows a band at 426 cm 1 assigned to the symmetric stretching vibration of the bonds in the P/SIS₄³⁻ moiety along with two other bands at 278 and 556 cm⁻¹. All three bands are slightly shifted from their position in typical [PS₄]³⁻ thiophosphates where they appear at 420, 270, and 550 cm⁻¹, respectively [16, 30, 59-61], supporting the substitution of Si for P in the tetrahedral unit.

In Li₄₊ₓP₁₋ₓSiₓS₄I, the iodide and free sulfide ions occupy two independent crystallographic sites, the 2c and 8i Wyckoff sites, respectively, owing to the much larger size of the iodide anion vs that of the sulfide (2.20 Å vs 1.84 Å respectively). This results in anion-ordering similar to other iodide-argyrodites such as Li₆PS₅I [30]. The (P/Si)S₄ tetrahedra are arranged in layers perpendicular to the c-axis propped apart by I⁻ ions (FIG. 1a). The Li ions reside in 4-, 5-, and 6-fold coordination environments that are completely disordered in the sub-lattice over four sites, the 2c, 2a, 8j, and 4d Wyckoff positions, with similar Li site occupancy fractions (SOFs; Tables 1 and 3) ranging from 0.45 to 0.65. The additional Li ions introduced in the lattice causes a redistribution of Li sites that forces a Li⁺-ion site configurational disorder and results in partial site occupancies; a critical condition for achieving high ionic conductivity [62,63]. The Li(1) and Li(4) sites are 6-fold coordinated to form a distorted octahedron with four sulfur and two iodine atoms, Li(2) is 4-fold coordinated by sulfur atoms, and Li(3) is a split site 5-fold coordinated by four sulfur and one iodine atom (FIG. 1b). Si and P share the 2a Wyckoff site with a (P/Si)—S bond length of 2.050(3) Å for x=0.12, and 2.053(7) Å for x=0.30 (Tables 6 and 8, respectively), which is slightly longer than the P—S bond length in Li₄PS₄I (2.040(1) Å) [38], β-Li₃PS₄ (2.004(2) Å) [64], and Li₇PS₆ (2.044(1) Å) [65]. The latter confirms the incorporation of Si⁴⁺ on the P⁵⁺ site.

The unsubstituted counterpart, Li₄PS₄I, crystallizes in the same tetragonal system, P4/nmm, No. 129, but with Z=4 owing to a doubled c-lattice parameter (a=b=8.4789(4) Å, c=11.8499(6) Å, and V=851.91(9) Å³; Table 2 and Tables 9-12). While the structure is very similar to Li₄₊ₓP₁₋ₓSiₓS₄I in terms of local anion coordination, the doubled c-parameter results from ordering of Li on the four crystallographically independent sites, which has not previously been elucidated for Li₄PS₄I. In our case, this finding was unambiguously proven by examining the reciprocal lattice of Li₄PS₄I obtained from the single-crystal data. Here, simulated precession images were calculated for the parent phase and the Si-doped phase from the full data sets (FIGS. 2a and 2b, respectively). The image of the undistorted layer of the reciprocal space 0kl for the parent phase, Li₄PS₄I, shows weak “supercell” reflections located between the main strong reflections (FIG. 2a), indicating the doubling of the unit cell along the c axis, while these supercell reflections are absent in the Si-doped phase (FIG. 2b).

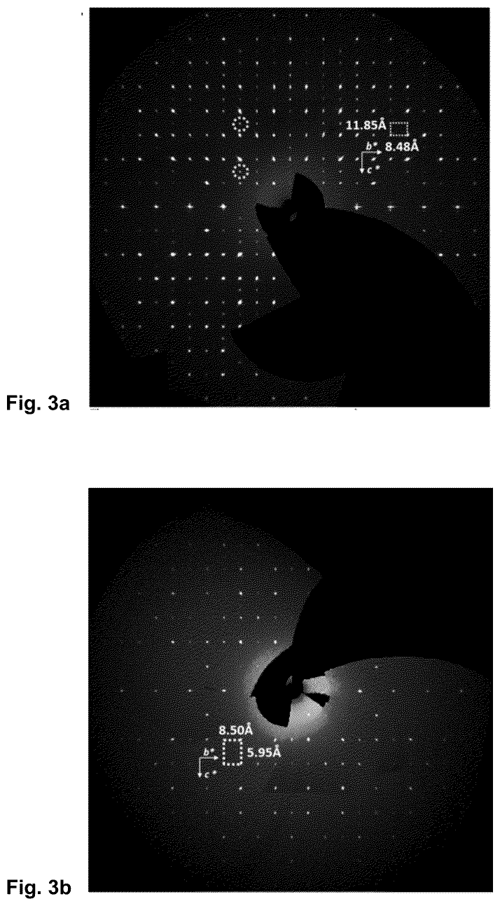

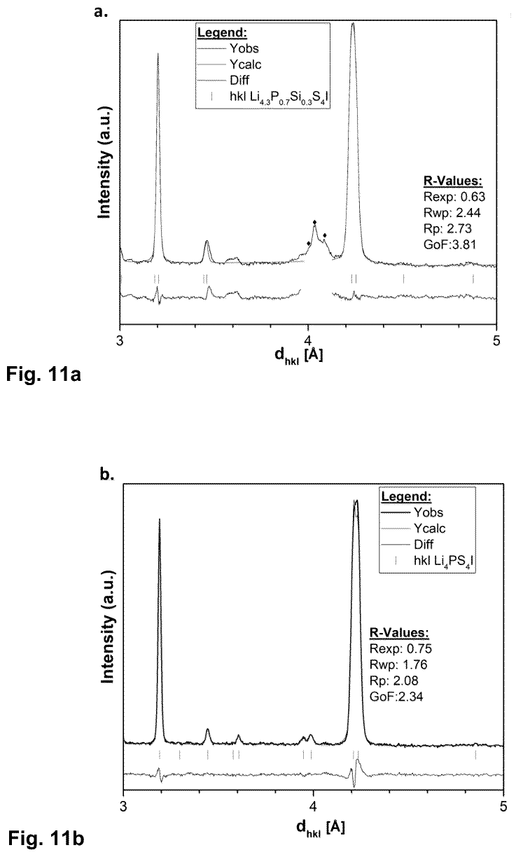

Neutron diffraction is a more sensitive probe of the Li-ion sublattice than X-ray diffraction owing to the large and negative neutron scattering length of Li and was used to confirm the findings from single-crystal XRD. FIGS. 3a and 3b show the Rietveld refinements against the time-of-flight (TOF) powder neutron diffraction (PND) patterns of microcrystalline Li_{4.3}P_{0.7}Si_{0.3}S₄I and Li₄PS₄I. The bulk sample of Li_{4.3}P_{0.7}Si_{0.3}S₄I—necessarily prepared in large quantity for the PND study—was majority single phase. However, it contained an impurity phase (ca. 8 wt %) that could not be identified and whose major Bragg reflections around 4.05 Å were excluded in the refinement. We note these reflections comprising a broad peak cannot be due to a supercell, because those would be much weaker in intensity, and sharper, as demonstrated by the simulated and experimental PND patterns of the parent phase as well as the simulated PND pattern of Li_{4.3}P_{0.7}Si_{0.3}S₄I (FIGS. 10 and 11). The Rietveld analysis of Li_{4.3}P_{0.7}Si_{0.3}S₄I refined to a composition of Li_{4.32(19)}P_{0.72(6)}Si_{0.28(6)}S₄I and—in excellent agreement with the single-crystal data-confirmed that the Li ions are disordered over the four sites with very similar Li site occupancies (Table 13).

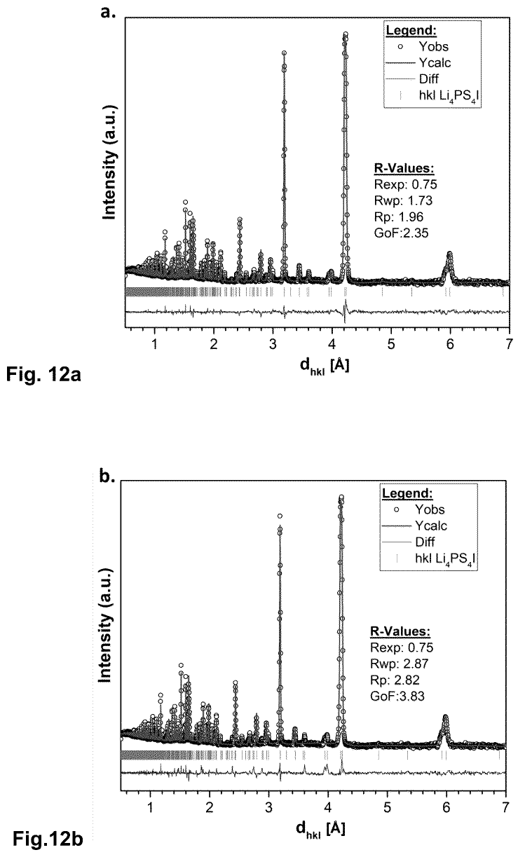

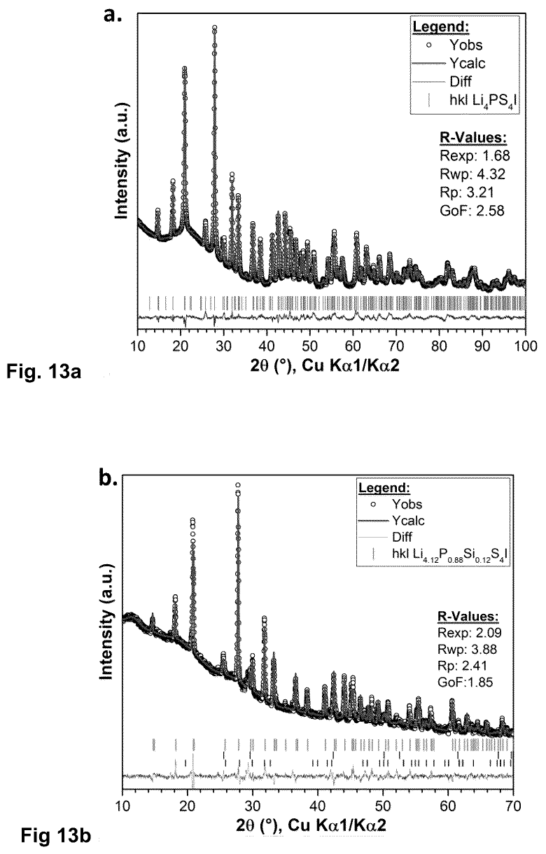

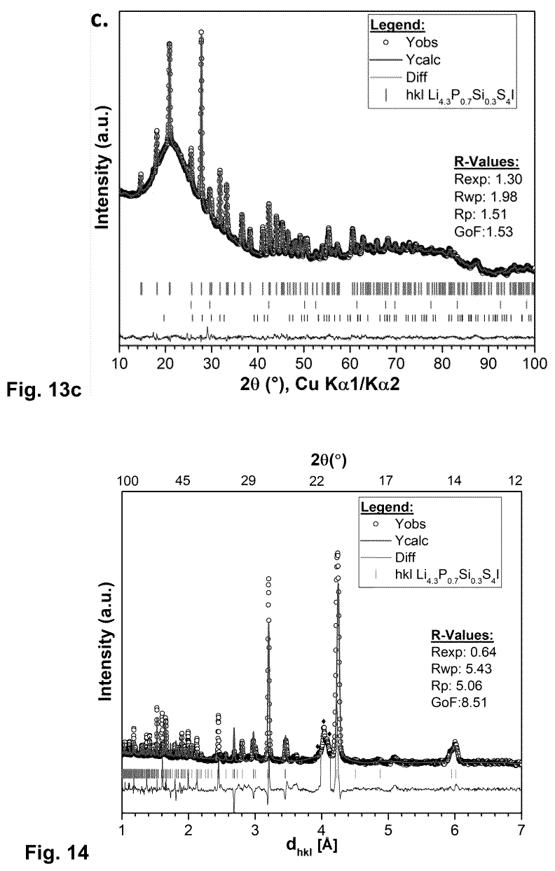

The Rietveld refinement against the PND pattern of Li₄PS₄I using the ordered model (P4/nmm; Z=4) demonstrates the existence of a fully ordered Li sub-lattice with a doubled c-axis (11.85 Å vs 5.927 Å in Li4.3P0.7Si0.3S4I; Table 14), in perfect accord with the single-crystal data described above. Here, the four Li sites in Li₄PS₄I were freely refined to obtain SOFs for Li(2) and Li(3) sites of 88% and 94%, respectively, whereas the Li(1) and Li(4) sites refined to slightly above 1 (1.042 and 1.008 respectively), giving a composition of Li_{3.81(28)}PS₄I. Therefore, (Li(1) and Li(4) were set to full occupancy of one), which is close to the targeted stoichiometry, and gave a suitable goodness-of-fitness (GoF) of 2.35 (Table 15 and FIG. 12a). A distinct decrease in the quality of the refinement (GoF=3.83) as well as a drop in the Li content (Li_{3.05(37)}PS₄I) was observed when the neutron TOF data was refined using the disordered crystal structure model based on the Si-substituted counterpart (Table 16 and FIG. 12b). These results confirm the accuracy of the ordered Li sub-lattice model for Li₄PS₄I. Rietveld refinements against powder XRD data of Li₄₊ₓP₁₋ₓSiₓS₄I (x=0, 0.12, and 0.30) are presented in FIG. 13a-c, respectively, and are also in close agreement with the single-crystal and neutron diffraction analysis. The PXRD patterns of the Li_{4.3}P_{0.7}Si_{0.3}S₄I samples did not show the unknown impurity phase (FIG. 13c) present in the PND data.

We note that previous reports suggested a disordered model for Li₄PS₄I (P4/nmm; Z=2) comprising five distinct Li sites [38], in contrast to our ordered crystal model for the parent phase with four Li sites (P4/nmm; Z=4). Accordingly, we attempted to refine the TOF neutron data of Li_{4.3}P_{0.7}Si_{0.3}S₄I using the reported disordered model with five Li sites [38], but this was not successful. A negative isotropic thermal parameter was obtained for the Li1 site, while the refined isotropic thermal parameter and occupancy of the Li2 site were both zero (Table 17). Furthermore, a low lithium content was obtained, Li=3.68(39), along with a very poor goodness-of-fitness, GoF: 8.51 (FIG. 14). Therefore, we believe that the previously reported five site model does not fit.

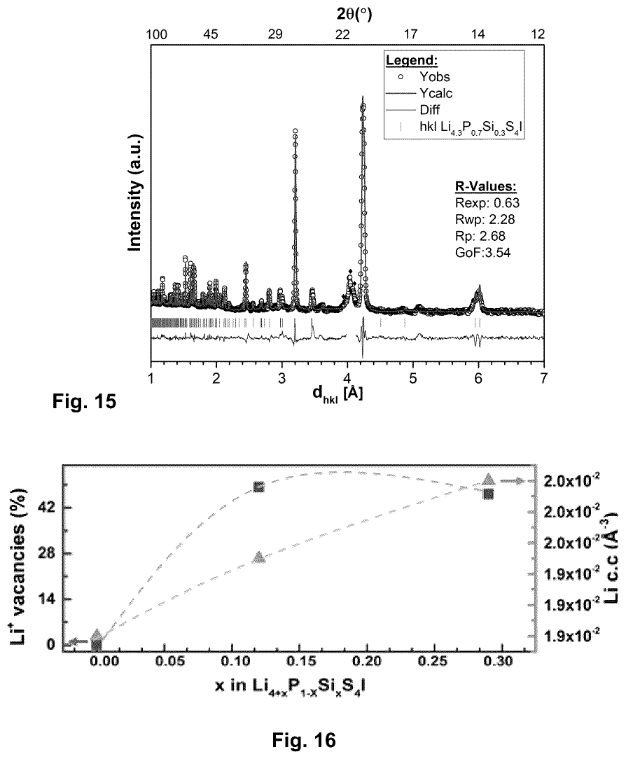

To further prove the validity of the disordered model for Li_{4.3}P_{0.7}Si_{0.3}S₄I, we attempted to refine the TOF PND data using the ordered Li sub-lattice model of Li₄PS₄I (doubled unit cell along c) (FIG. 15 and Table 16), including an additional 2a Wyckoff site for Li to accommodate the increase of Li content with incorporation of Si onto the lattice (x(Li⁺¹+Si⁺⁴ for P⁺⁵)). However, the Li-ion content refined to only Li_{3.81(3)}, considerably lower than the targeted value of Li=4.3, while refinement using our disordered crystallographic model with four Li sites yielded a refined Li-ion content of Li_{4.32(19)} in excellent accord with the target.

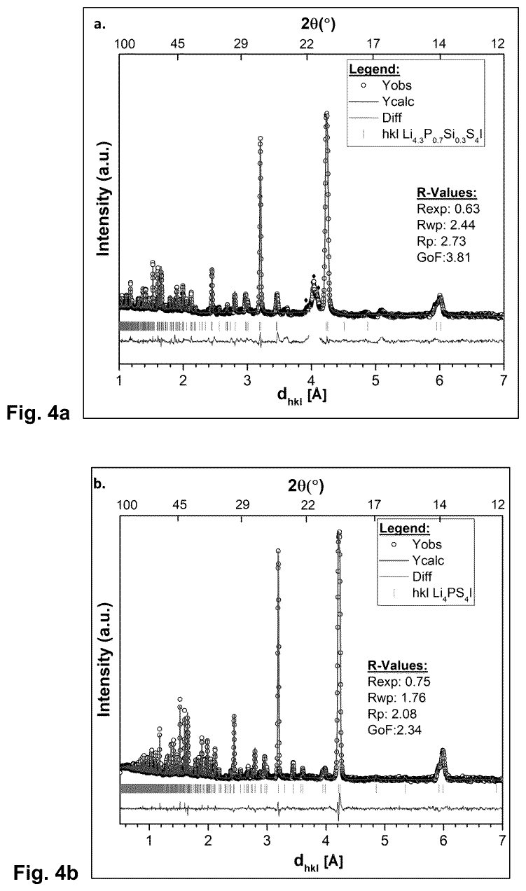

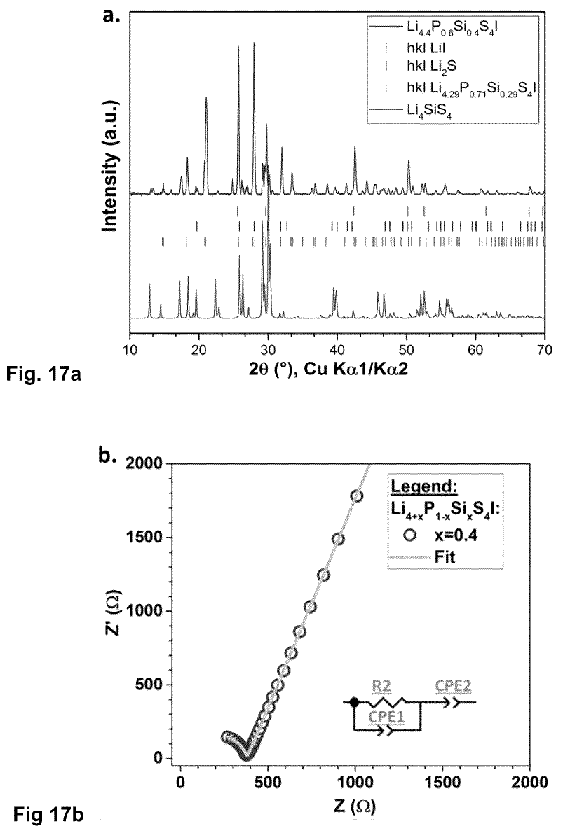

The structures of Li₄PS₄I and Li_{4.3}P_{0.7}Si_{0.3}S₄I are compared in FIGS. 4a and 4b in a view down the [100] axis. As emphasized above, the Li₄PS₄I phase (Z=4) framework exhibits an ordered Li-sublattice with all four lithium sites fully occupied (FIG. 4a). This accounts for its poor conductivity as described below and is in sharp contrast with the highly disordered Li substructure of Li_{4.3}P_{0.7}Si_{0.3}S₄I shown in FIG. 4b. With incorporation of Si and Li into the lattice (x(Li⁺¹+Si⁺⁴ for P⁺⁵)) a high fraction of Li⁺ vacancies is generated in the Li₄₊ₓP₁₋ₓSiₓS₄I framework; 48% for x=0.12 and 46% for x=0.30 (FIG. 16), leading to the Li-ion disordering that must occur to accommodate the additional Li ions “stuffed” into the structure. The unit cell volume increases from 851.91(9) Å³ for x=0 to 861.2(2) Å³ for x=0.3 (considering the doubling of the unit cell of the former), as a result of the disorder and vacancy population on the four available Li sites, which is consistent with the DFT calculations (see below). Attempts to introduce additional silicon and lithium into the structure caused ex-solvation of Li₄SiS₄ at x=0.4, likely due to the thermodynamic instability of the lattice at higher lithium concentrations (FIG. 17a).

### Li-Ion Conductivity

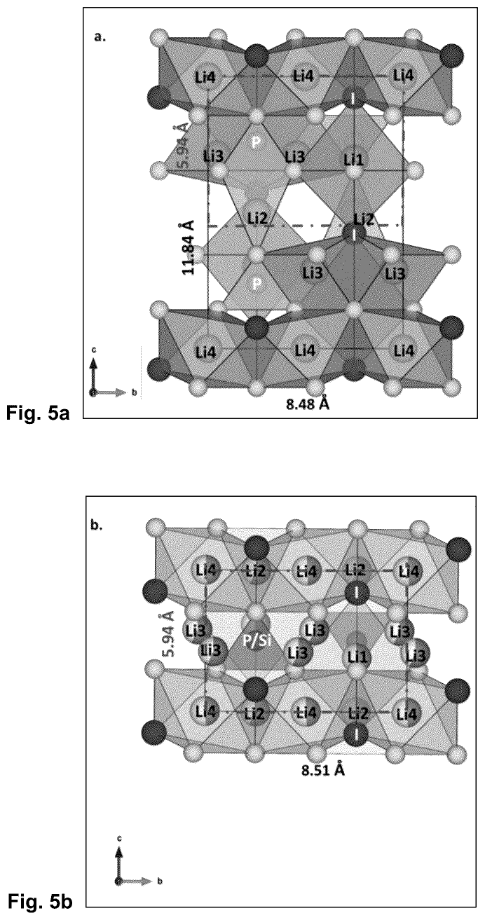

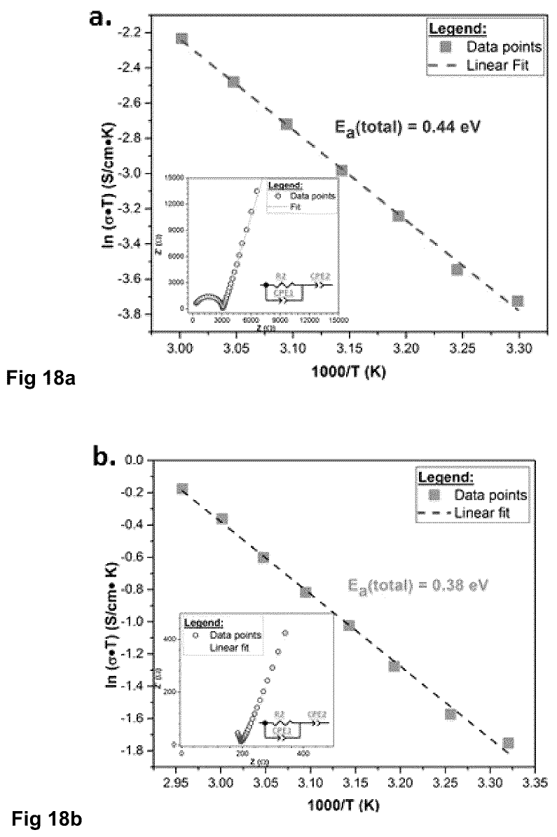

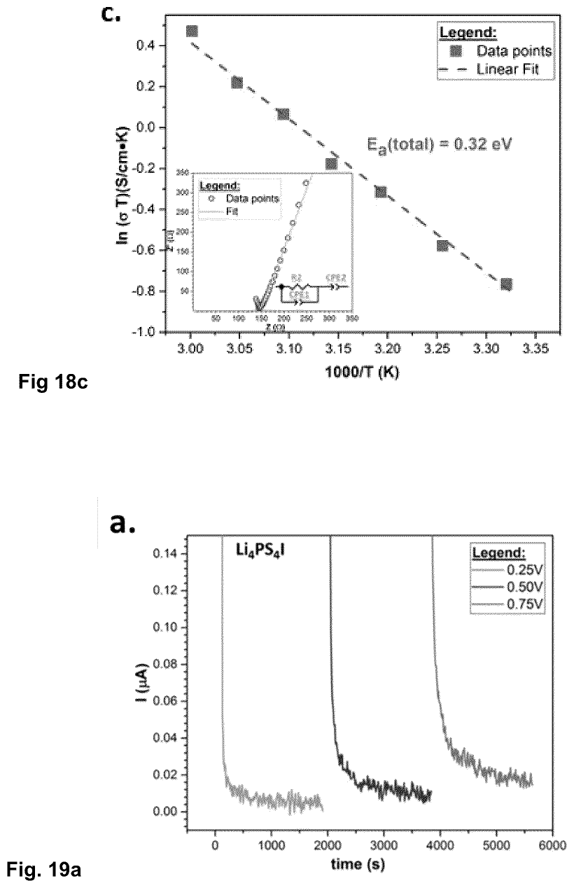

The ion transport behavior of the Li₄₊ₓP₁₋ₓSiₓS₄I materials was investigated by electrochemical impedance spectroscopy (EIS) measurements. The Nyquist plots exhibit a semicircle in the high-frequency region and a linear Warburg element in the low-frequency region, which is characteristic of ionic conductors. The corresponding impedance responses illustrated as a Nyquist plot of Li₄₊ₓP₁₋ₓSiₓS₄I are shown in FIG. 5a. The impedance data were fit to an equivalent circuit consisting of a resistor (R) in parallel with a constant phase element (CPE) for the ion transport, in series with a CPE that represents the blocking electrodes (Table 19). The total ionic conductivity and error are determined from the average of conductivities obtained from the span in the measurements for various samples of the same composition. Values obtained from the impedance analyses are presented in Table 20. With increasing fraction of Si⁴⁺ and thus Li⁺ in Li₄₊ₓP₁₋ₓSiₓS₄I (FIG. 5b), the conductivity increases over two orders of magnitude from 0.046(6) mS·cm⁻¹ for x=0 to a maximum of σ(Li⁺)=1.46 (2) mS·cm⁻¹ at x=0.30 (Li_{4.3}P_{0.7}Si_{0.3}S₄I). At x=0.40 the conductivity drops to 0.38(7) mS·cm⁻¹ (FIG. 17b) due to the ex-solvation of the resistive Li₄SiS₄ impurity phase observed in the PXRD pattern (FIG. 18a). Sample preparation may also affect the conductivity measurements.

Temperature-dependent impedance spectroscopy was performed to assess the changes in ionic conductivity of Li₄₊ₓP₁₋ₓSiₓS₄I with x=0, 0.12, and 0.30. The ionic conductivity obeys Arrhenius behavior in the temperature range shown in FIGS. 18a-c, enabling determination of the activation energies (Eₐ) for Li⁺ ion diffusion. The Eₐ for Li⁺-ion diffusion gradually decreases as the Li-ion content in the lattice increases, from 0.44 eV for Li₄PS₄I to 0.32 eV for Li_{4.3}P_{0.7}Si_{0.3}S₄I (FIG. 5b). The maximal configurational entropy and ionic conductivity are achieved when the concentration of mobile ions is equal to that of the vacancies [60], which is effectively the case in Li_{4.3}P_{0.7}Si_{0.3}S₄I (FIG. 16). The highly disordered mobile carrier sub-lattice, resulting in about 50% Li-ion occupancy on each of four well-connected sites with a low barrier migration for Li-ion migration—and the increased Li ion carrier concentration—explain the relationship between conductivity and structure. This proves that the approach of stuffing the lattice with Li-ions has a remarkable influence on creating disorder in the Li substructure and thus on the ion transport properties, as has been observed for substitution of Li⁺/Ge⁴⁺ in Li₆₊ₓP₁₋ₓGeₓS₅I [66,67]; Li⁺/Si⁴⁺ in Li₃₊ₓ[SiₓP₁₋ₓ]S₄ [68]; and Li⁺/M⁺⁴ in Li₆₊ₓMₓSb₁₋ₓS₅I (M⁴⁺=Si, Ge, Sn) [29].

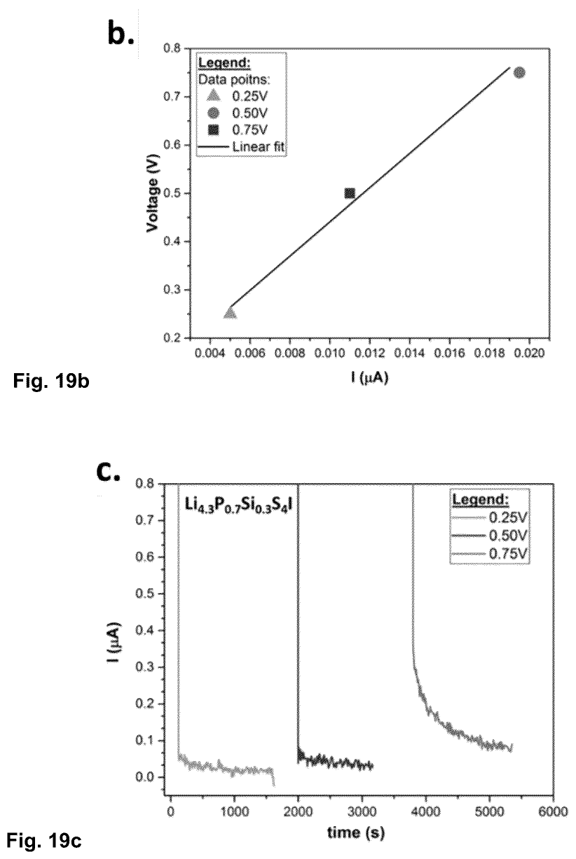

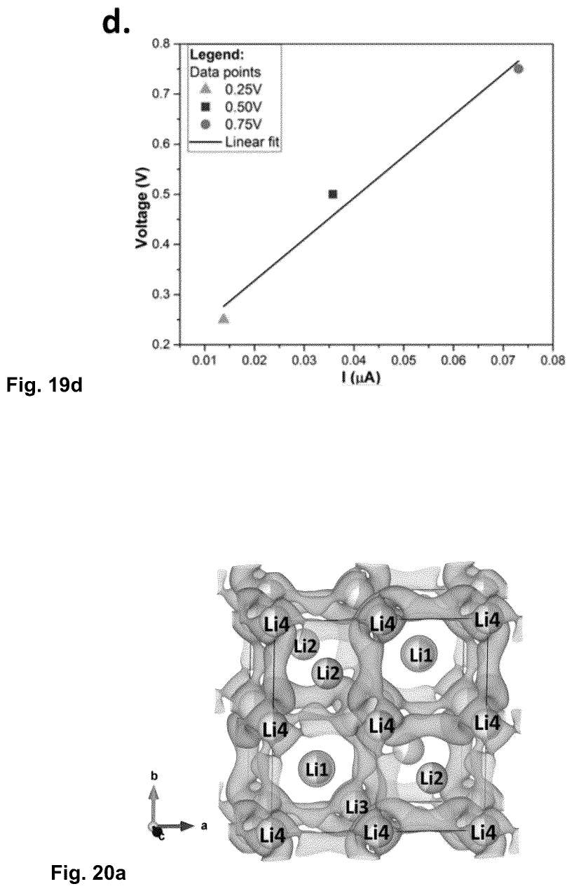

The electronic conductivities of Li₄PS₄I and Li_{4.3}P_{0.7}Si_{0.3}S₄Iwere measured by DC polarization measurements of the SS/SE/SS symmetric cells at three different voltages (0.25 V, 0.50 V, and 0.75 V). From a linear fit of DC voltage and stabilized current (FIGS. 19a-19c), the DC electronic conductivities are estimated to be 1.02×10⁻⁸ S·cm⁻¹ for Li₄PS₄I, and 1.8×10⁻⁹ S·cm⁻¹ for Li_{4.3}P_{0.7}Si_{0.3}S₄I. The high ionic conductivity and the order-of-magnitude lower electronic conductivity makes the Si substituted material favorable as a solid electrolyte owing to a transference number close to one.

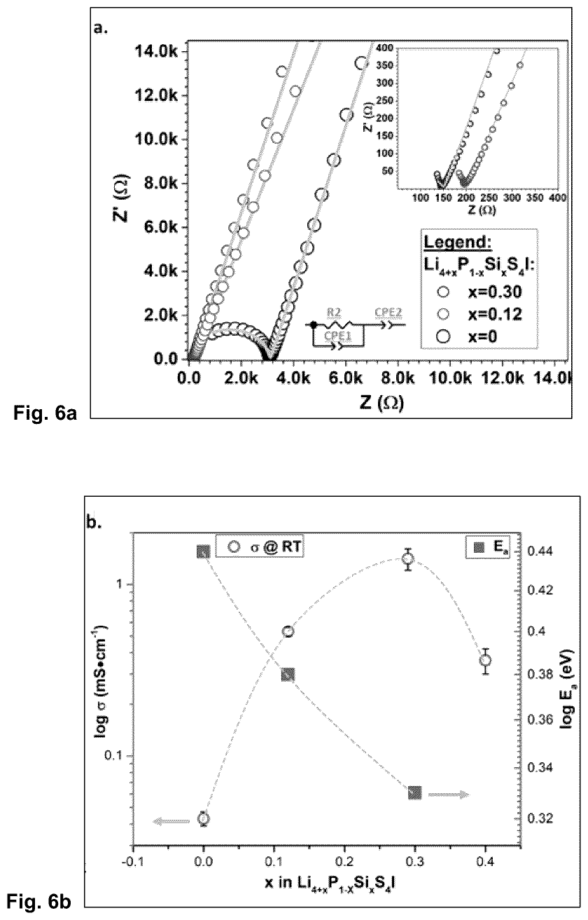

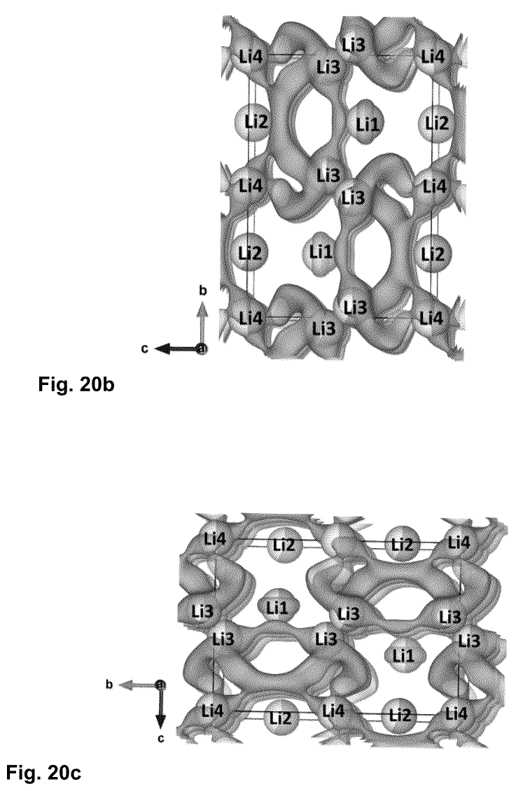

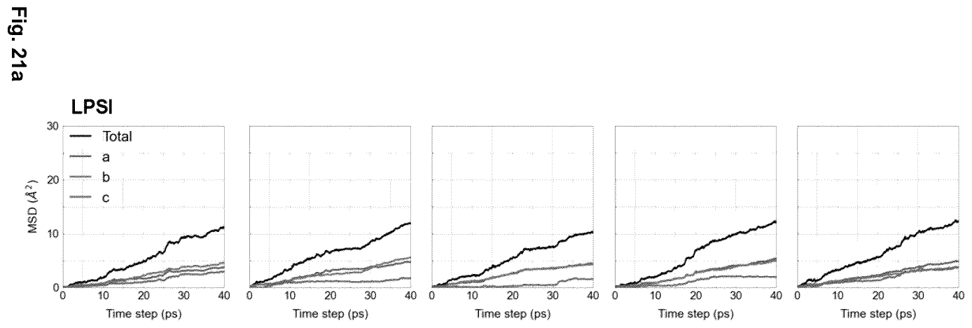

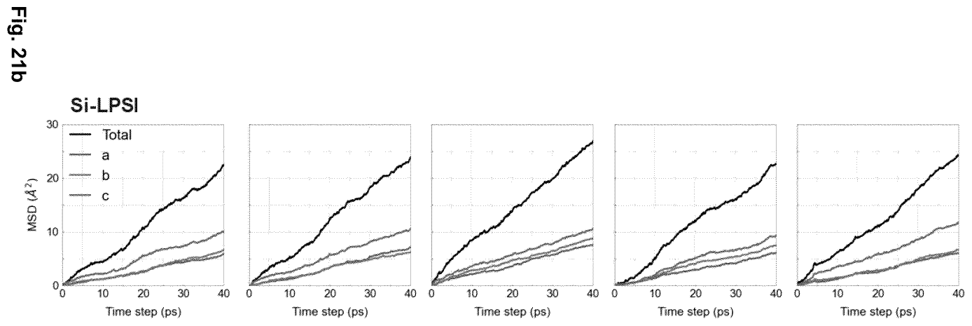

Insights into the Li-ion diffusion pathways in the Li_{4.3}P_{0.7}Si_{0.3}S₄I framework were obtained from the bond valence site energy (BVSE) method with an energy of E_{BVSE(Li)}=0.56 eV over the global minimum. Analysis of the bond valence maps along the [001], [010], and [100] directions shown in FIGS. 6a-c show that based on this average structure model, Li3-Li4 sites form the first 1D pathway, which is connected to a 3D network via the Li2 site and an interstitial site (i1) at 0.75, 0.073, 0.903 (Wyckoff 8i) with a maximum activation barrier of about 0.4 eV. Migration through the i1 site shortens the ion diffusion between Li(4) and Li(4) sites from 4.25(4) Å to 2.28(18) Å contributing to Li-ion diffusion along the a and b-axes through the Li(4)-i1-Li(2)-i1-Li(4) chain. The BVSE map (FIG. 6b) along the [010] direction also exhibits lithium diffusion along the c-axis involving the Li(4) and Li(3) sites. The Li1 site is connected to the 3D pathway only at a higher migration barrier, which is reflected in the large distance to the next-neighboring lithium site (Li3), 2.785(14) Å, in accordance with previous reports on the parent phase, Li₄PS₄I [47,70]. These findings are further supported by the maximum-entropy method (MEM). The structure factors obtained from the Rietveld analysis of the TOF neutron data were used as an initial input to calculate the Li-ion nuclear density distribution. The lithium negative nuclear density maps for Li_{4.3}P_{0.7}Si_{0.3}S₄I in the b,c-, a,b-, and a,c-planes (FIG. 20) show that partial filling of the interstitial Li site (i1) identified by BVSE analysis (FIG. 6a) is needed to facilitate the 3D lithium diffusion in Li_{4.3}P_{0.7}Si_{0.3}S₄I.

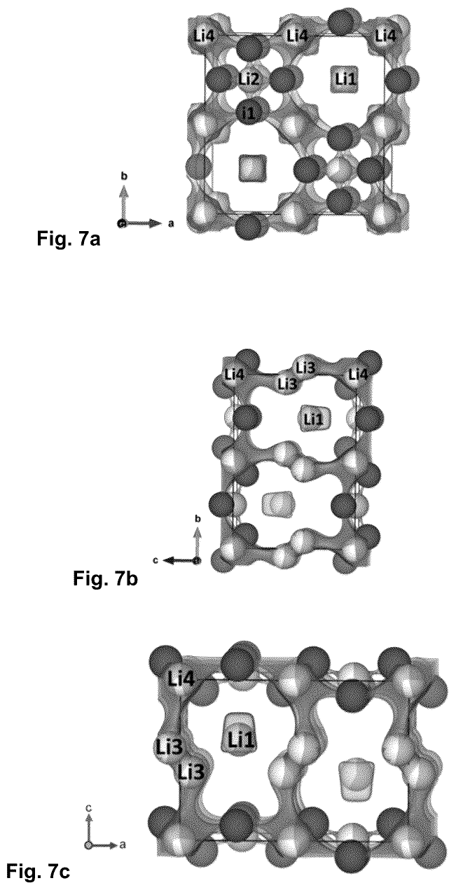

The Li-ion diffusion pathways and associated dynamics were further analyzed and compared between Li_{4.3}P_{0.7}Si_{0.3}S₄I and Li₄PS₄I by AIMD simulations. The simulations were carried out at five elevated temperatures ranging from 600 K to 1000 K for both materials using the structure models highlighted in FIG. 7a. The Li-ion diffusion coefficients were extracted along the pathways identified in the AIMD simulations (FIG. 21). FIG. 7b shows the Arrhenius plot for the diffusion coefficients obtained at temperatures ranging from 600 K to 1000 K. Although the diffusivities are similar for both materials at higher temperatures (800-1000 K), when temperature drops below 800 K, Li-ion diffusivity in LPSI is much lower than in Si-LPSI, as evidenced in change in slope, i.e., the activation energy, in FIG. 7b. The Eₐ of Li-diffusion in LPSI extracted from the high temperature region (800-1000 K) is 0.21 eV but becomes 0.39 eV in the low temperature region (600-800 K), in close agreement with the experimentally determined activation energy of 0.44 eV at RT, while a theoretical ion conductivity of 0.32 mS·cm⁻¹ was obtained at 300 K, which is higher than our experimental value of 0.046 mS·cm⁻¹ at room temperature. In the case of Si-LPSI, no slope change is observed in the Arrhenius plot and an overall activation energy of 0.22 eV is obtained with a theoretical ion conductivity of 15.9 mS·cm⁻¹ extrapolated down to 300 K. The Eₐ of 0.22 eV is the same as measured by NMR analysis for Li₄PS₄I prepared via a solution route (0.23(1) eV) [38], although of course these NMR measurements are an estimate of the activation energy barrier to local hopping, not long-range diffusivity. We note that the computed activation energy is lower than the experimental value of 0.32 eV while the predicted conductivity is higher than the measured value for Li_{4.3}P_{0.7}Si_{0.3}S₄I, which could be due to subtle difference in Si content and the existence of secondary phases or grain boundaries in the experimental samples.

The Li-ion probability density isosurfaces are shown in FIG. 8c from the AIMD simulations performed at 600 K for LPSI and Si-LPSI. It is observed that at this temperature, half of the Li(1) and Li(4) sites, shown in blue and red, respectively, in LPSI are barely accessible likely due to their highly ordered nature. For the case of Li(4) sites, low Li-ion probability densities are observed in every other (001) plane as shown in two different ab planes at z=0.5 and z=0.75 in FIG. 8c, suggesting discontinued Li-ion diffusion channel along the c-axis in LPSI through Li(3) and Li(4) sites. In the ab plane, Li-ions migrate predominantly through the Li(2) and Li(4) sites, which are moderately blocked due to the partially accessible Li(4) sites (FIG. 8c). As a result, Li-ion diffusion in LPSI is anisotropic at 600 K, with slower diffusion along the c-axis (FIG. 21), whereas in Si-LPSI, clear 3D diffusion pathways are identified, which differs from the BVSE results since an average structure model was used for the latter.

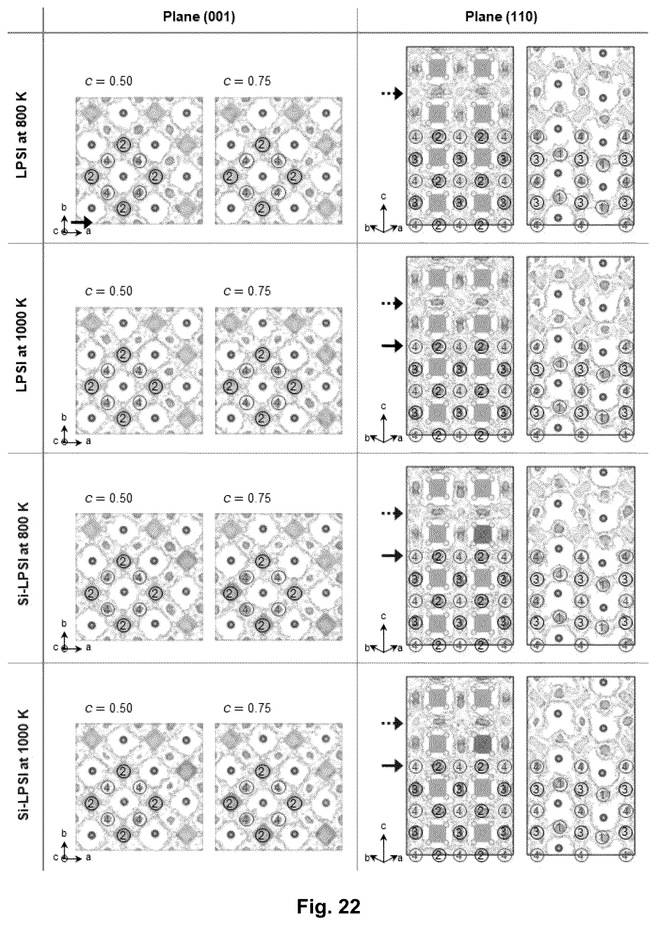

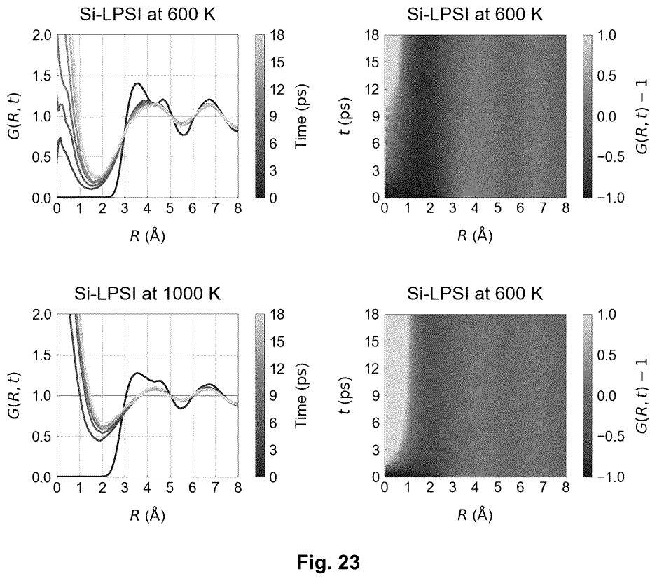

The difference in Li-ion probability densities between LPSI and Si-LPSI at 600 K disappears at high temperatures (800-1000 K, FIG. 22) as all four Li sites become equivalently available for Li-ion diffusion. Moreover, in contrast to the other four targeted temperatures (600 K, 700 K, 900 K, and 1000 K) that show the same Li-sublattice arrangement between the five investigated structural models, at 800 K the five structural models showed ordered and disordered Li-ion sublattice configurations. Based on these results, we expect LPSI undergoes a disorder-order phase transition in terms of Li sub-lattice around 700 K-800 K. In contrast, Si-LPSI maintains its disordered phase in this entire temperature range that contributes to the observed 600 K diffusivity (and is clearly maintained down to room temperature based on experiments). Our initial calculations of the van Hove correlation function Gd at different MD temperatures (600 K and 1000 K, FIG. 23) show that Si-LPSI exhibits a pronounced peak at around r<2 Å region, suggesting that the Li ion motion in this material is highly correlated in accordance with the highly delocalized Li-ion density described above.

### Conclusions

Using a combination of single-crystal X-ray and powder neutron diffraction, impedance spectroscopy, the bond valence site energy method and ab initio molecular dynamics simulations, we found that the low ionic conductivity of Li₄PS₄I can be explained by the existence of a fully ordered Li sublattice, while its ion conductivity is vastly improved by stuffing the lattice with additional Lit ion via aliovalent substitution of x (Li⁺¹+Si⁺⁴) for P⁺⁵. With increasing Li/Si content in Li₄₊ₓP₁₋ₓSiₓS₄I (where 0.1<x<0.4, such as x=0.12 or 0.30), a significant increase in ionic conductivity and decrease in activation energy coincides with the onset of configurational disorder of the Li sub-lattice. Aliovalent substitution converts the poorly conductive, fully ordered Li₄PS₄I phase, to a highly conductive/fully disordered phase, for example Li_{4.3}P_{0.7}Si_{0.3}S₄I, with a high concentration of lithium vacancies (˜46%) and high Li-ion carrier concentration. The structural changes were found to lead to an increased ionic conductivity of two orders of magnitude, from 0.046 (6) mS·cm⁻¹ for Li₄PS₄I to 1.46(2) mS·cm⁻¹ for Li_{4.3}P_{0.7}Si_{0.3}S₄I and a decrease in the activation barrier for Li-ion migration from 0.44 eV for x=0 to 0.32 eV for x=0.30 in Li₄₊ₓP₁₋ₓSiₓS₄I. Studies using the bond valence site energy method, and ab-initio molecular dynamics protocols show, and clearly demonstrate the existence of 3D diffusion pathways in the Si-substituted material, where all the Li atoms in the four distinct sites take part in ion diffusion. An even lower Eₐ (0.22 eV) and higher conductivity is predicted (13.8 mA·cm⁻¹). This demonstrates that inducing formation of a disordered mobile carrier sub-lattice is a promising strategy towards the development of new, fast ion conductors.

Although the above description includes reference to certain specific embodiments, various modifications thereof will be apparent to those skilled in the art. Any examples provided herein are included solely for the purpose of illustration and are not intended to be limiting in any way. Any drawings provided herein are solely for the purpose of illustrating various aspects of the description and are not intended to be drawn to scale or to be limiting in any way. The scope of the claims appended hereto should not be limited by the preferred embodiments set forth in the above description but should be given the broadest interpretation consistent with the present specification as a whole. The disclosures of all references in the present description herein are incorporated herein by reference in their entirety.

### Tables

TABLE 1
Atomic coordinates, occupation fraction and isotropic displacement parameters
of Li4.3P0.7Si0.3S4I obtained from single-crystal X-ray diffraction at 280K.

| | Wyckoff | | | | | |
|---|---|---|---|---|---|---|
| Atom | site | x | y | z | SOF^{a} | U(eq) (Å²) |
| P | 2b | ¾ | ¼ | ½ | 0.71(11) | 0.0179(5) |
| Si | 2b | ¾ | ¼ | ½ | 0.29(11) | 0.0179(5) |
| S | 8i | ¼ | 0.55519(8) | 0.70352(11) | 1 | 0.02088(18) |
| I | 2c | ¼ | ¼ | 0.15774(6) | 1 | 0.02643(16)^{a} |
| Li1 | 2c | ¼ | ¼ | 0.617(4) | 0.58(5) | 0.043(8) |
| Li2 | 2a | ¾ | ¼ | 0 | 0.65(5) | 0.039(4) |
| Li3 | 8j | 0.0438(10) | 0.0438(10) | 0.4230(19) | 0.54(2) | 0.04230(19) |
| Li4 | 4d | 0 | 0 | 0 | 0.46(3) | 0.064(9) |

The total occupancy on the 2b site was constrained to be 1, while the Si/P ratio was freely refined. (a) The iodine interacts only with the mobile lithium, and because I is an isolated anion its Ueq is larger than that of P/Si and S atoms which are bonded in the tetrahedral motif)

TABLE 2
Atomic coordinates, occupation fraction and isotropic displacement parameters
of Li₄PS₄I obtained from single-crystal X-ray diffraction at 280K.

| | Wyckoff | | | | | |
|---|---|---|---|---|---|---|
| Atom | site | x | y | z | SOF^{a} | U(eq) (Å²) |
| P | 4f | ¾ | ¼ | 0.23808(5) | 1 | 0.01285(13) |
| S1 | 8i | ¼ | 0.55085(5) | 0.85705(4) | 1 | 0.01798(11) |
| S2 | 8i | ¼ | 0.55964(5) | 0.34542(4) | 1 | 0.01769(11) |
| I1 | 2c | ¼ | ¼ | 0.07640(2) | 1 | 0.02508(9) |
| I2 | 2c | ¼ | ¼ | 0.57613(2) | 1 | 0.02168(9) |
| Li1 | 2c | ¼ | ¼ | 0.3040(7) | 1 | 0.0339(18) |
| Li2 | 2b | ¾ | ¼ | ½ | 1 | 0.0314(16) |
| Li3 | 8j | 0.0457(3) | 0.0457(3) | 0.7120(3) | 1 | 0.0319(8) |
| Li4 | 4d | 0 | 0 | 0 | 1 | 0.0546(17) |

^{a}In Table 2, the Li occupancies were first refined freely, showing a slight deficiency. As a check conducted to search for electron density in other sites did not reveal any, the Li occupancies were set to 100% for charge neutrality.

TABLE 3
Crystallographic data for Li_{4.12}P_{0.88}Si_{0.12}S₄I and Li_{4.3}P_{0.7}Si_{0.3}S₄I
obtained from single-crystal X-ray diffraction at 280 K.

| Crystal data | 280 K | 280 K |
|---|---|---|
| Formula | Li_{4.14(13)}P_{0.88(6)}Si_{0.12(6)}S₄I | Li_{4.31(24)}P_{0.1(11)}Si_{0.29(11)}S₄I |
| Formula Weight | 314.53 | 315.30 |
| Crystal System | Tetragonal | Tetragonal |
| Space group | P4/nmm (No. 129) | P4/nmm (No. 129) |
| a = b, c (Å) | 8.4813(6), 5.9270(4) | 8.5090(7), 5.9473(5) |
| V (Å³) | 426.34(7) | 430.60(8) |
| Z | 2 | 2 |
| Calc. density (g/cm³) | 2.450 | 2.432 |
| Abs. coef. μ (MoKa) (/mm) | 4.816 | 4.760 |
| F (000) | 289 | 289 |
| Crystal Size (mm) | 0.160 × 0.060 × 0.010 | 0.050 × 0.040 × 0.020 |
| Data Collection | | |
| Temperature (K) | 280 | 280 |
| Radiation (Å) | Mo-Kα 0.71073 | Mo-Kα 0.71073 |
| Theta range for data | 3.397 to 29.926 | 3.386 to 29.817 |
| collection (°) | | |
| Index ranges | −11 <= h <= 11, −11 <= | −11 <= h <= 11, −10 <= |
| | k <= 8, −7 <= l <= 8 | k <= 10, −8 <= l <= 7 |
| Reflections collected | 4313 | 3292 |
| Independent reflections | 384 [R(int) = 0.0138] | 384 [R(int) = 0.0324] |
| Completeness to Θ = | 100% | 100.0% |
| 25.242° | | |
| Absorption correction | Semi-empirical from | Semi-empirical from |
| | equivalents | equivalents |
| Max. and min. | 0.7460 and 0.6528 | |
| transmission | | |
| Refinement | | |
| Refinement method | Full-matrix least-squares on F² | Full-matrix least-squares on F² |
| Data/restraints/ | 384/0/32 | 384/0/33 |
| parameters | | |
| Goodness-of-fit on F² | 1.241 | 1.119 |
| Final R indices | R1 = 0.0088, wR2 = 0.0206 | R1 = 0.0193, wR2 = 0.0394 |
| [I > 2sigma(I)] | | |
| R indices (all data) | R1 = 0.0094, wR2 = 0.0207 | R1 = 0.0259, wR2 = 0.0417 |
| Largest diff. peak and hole | 0.405 and −0.229 | 0.878 and −0.360 |
| (e · Å⁻³) | | |

TABLE 4
Crystallographic data for Li_{4.12}P_{0.88}Si_{0.12}S₄I
obtained from single-crystal X-ray diffraction at 280K.

| | Wyckoff | | | | | |
|---|---|---|---|---|---|---|
| Atom | site | x | y | z | SOF | U(eq) (Å²) |
| P | 2b | ¾ | ¼ | ½ | 0.88(6) | 0.0168(3) |
| Si | 2b | ¾ | ¼ | ½ | 0.12(6) | 0.0168(3) |
| S | 8i | ¼ | 0.55464(3) | 0.70368(5) | 1 | 0.01611(7) |
| I | 2c | ¼ | ¼ | 0.15774(6) | 1 | 0.01872(6) |
| Li1 | 2c | ¼ | ¼ | 0.6118(18) | 0.51(3) | 0.030(4) |
| Li2 | 2a | ¾ | ¼ | 0 | 0.62(2) | 0.026(3) |
| Li3 | 8j | 0.0444(4) | 0.0444(4) | 0.4239(9) | 0.527(11) | 0.0283(15) |
| Li4 | 4d | 0 | 0 | 0 | 0.449(17) | 0.042(3) |

TABLE 5
Anisotropic displacement parameters (Å2) of Li_{4.12}P_{0.88}Si_{0.12}S₄I
obtained from single-crystal X-ray diffraction at 280K.

| Atom | ^{U}11 | ^{U}22 | ^{U}33 | ^{U}23 | ^{U}13 | ^{U}12 |
|---|---|---|---|---|---|---|
| P | 0.0096(3) | 0.0096(3) | 0.0312(4) | 0 | 0 | 0 |
| Si | 0.0096(3) | 0.0096(3) | 0.0312(4) | 0 | 0 | 0 |
| S | 0.01643(14) | 0.01199(13) | 0.01990(15) | 0 | 0 | 0 |
| I | 0.02117(7) | 0.02117(7) | 0.01382(8) | 0 | 0 | 0 |
| Li1 | 0.033(4) | 0.033(4) | 0.022(6) | 0 | 0 | 0 |
| Li2 | 0.030(3) | 0.030(3) | 0.017(4) | 0 | 0 | 0 |
| Li3 | 0.0259(18) | 0.0259(18) | 0.033(3) | −0.0013(14) | −0.0013(14) | 0.0062(18) |
| Li4 | 0.048(4) | 0.048(4) | 0.032(5) | 0.005(3) | 0.005(3) | −0.017(4) |

TABLE 6
Bond distances in Li_{4.12}P_{0.88}Si_{0.12}S₄I obtained
from single-crystal X-ray diffraction at 280 K.

| Atom1 | Atom2 | Bond Distance (Å) |
|---|---|---|
| P/Si | S1 | 2.0501(3) × 4 |
| Li1 | S1 | 2.641(3) × 4 |
| Li1 | I | 2.702(11), 3.225(11) |
| Li2 | S1 | 2.4145(3) × 4 |
| Li3 | S1 | 2.549(5) × 2 2.610(4) × 2 |
| Li3 | I | 2.933(5) × 2 |
| Li4 | S1 | 2.7920(2) × 4 |
| Li4 | I | 3.1378(2) × 2 |
| Li1 | Li3 | 2.706(7) × 2, 3.538(5) × 2 |
| Li2 | Li4 | 2.9986(2) × 2 |
| Li3 | Li3 | 1.396(9) |
| Li3 | Li4 | 2.568(5), 3.456(5) |

TABLE 7
Anisotropic displacement parameters (Å2) of Li_{4.3}P_{0.7}Si_{0.3}S₄I
obtained from single-crystal X-ray diffraction at 280K.

| Atom | ^{U}11 | ^{U}22 | ^{U}33 | ^{U}23 | ^{U}13 | ^{U}12 |
|---|---|---|---|---|---|---|
| P | 0.0122(6) | 0.0122(6) | 0.0295(8) | 0 | 0 | 0 |
| Si | 0.0122(6) | 0.0122(6) | 0.0295(8) | 0 | 0 | 0 |
| S | 0.0234(4) | 0.0155(3) | 0.0236(3) | 0.0001(2) | 0 | 0 |
| I | 0.030(1) | 0.030(1) | 0.01904(19) | 0 | 0 | 0 |
| Li1 | 0.042(10) | 0.042(10) | 0.045(13) | 0 | 0 | 0 |
| Li2 | 0.045(9) | 0.045(9) | 0.026(9) | 0 | 0 | 0 |
| Li3 | 0.034(4) | 0.034(4) | 0.050(7) | −0.001(4) | −0.001(4) | 0.013(5) |
| Li4 | 0.069(12) | 0.069(12) | 0.054(13) | 0.012(8) | 0.012(8) | −0.014(13) |

TABLE 8
Bond distances in Li_{4.3}P_{0.7}Si_{0.3}S₄I obtained from
single-crystal X-ray diffraction at 280 K.

| Atom1 | Atom2 | Bond Distance (Å) |
|---|---|---|
| P/Si | S1 | 2.0525(7) × 4 |
| Li1 | S1 | 2.641(3) × 4 |
| Li1 | I | 2.73(2), 2.940(12) |
| Li2 | S1 | 2.4201(7) × 4 |
| Li3 | S1 | 2.613(9) × 2, 2.563(10) × 2 |
| Li3 | I | 2.940(10), 2.933(5) |
| Li4 | S1 | 2.8026(5) × 4 |
| Li4 | I | 3.1513(3) × 2 |
| Li1 | Li3 | 2.738(15) × 2, 3.538(5) × 2 |
| Li2 | Li4 | 3.0084(3) × 2 |
| Li3 | Li3 | 1.40(2) |
| Li3 | Li4 | 2.570(11) 3.472(11) |

TABLE 9
Crystallographic data for Li₄PS₄I obtained from
single-crystal X-ray diffraction at 280 K.

| Crystal data | 280 K |
|---|---|
| Formula | Li₄PS₄I |
| Formula Weight | 313.87 |
| Crystal System | Tetragonal |
| Space group | P4/nmm (No. 129) |
| a = b, c (Å) | 8.4789(4), 11.8499(6) |
| V (Å³) | 851.91(9) |
| Z | 4 |
| Density (g/cm³) | 2.447 |
| Abs. coef. μ (MoKα) (/mm) | 4.825 |
| F (000) | 576 |
| Crystal Size (mm) | 0.180 × 0.070 × 0.010 |
| Data Collection | |
| Temperature (K) | 280 |
| Radiation (Å) | Mo-Kα 0.71073 |
| Theta range for data collection (°) | 1.718 to 27.985 |
| Index ranges | −7 <= h <= 11, −11 <= k <= 11, −15 <= l <= 15 |
| Reflections collected | 15222 |
| Independent reflections | 638 [R(int) = 0.0166] |
| Completeness to Θ = 25.242° | 100.0% |
| Absorption correction | Semi-empirical from equivalents |
| Refinement | |
| Refinement method | Full-matrix least-squares on F² |
| Data/restraints/parameters | 638/0/39 |
| Goodness-of-fit on F² | 1.246 |
| Final R indices [I > 2sigma(I)] | R1 = 0.0107, wR2 = 0.0240 |
| R indices (all data) | R1 = 0.0132, wR2 = 0.0301 |
| Largest diff. peak and hole (e · Å⁻³) | 0.308 and −0.379 |

TABLE 10
Atomic coordinates, occupation fraction and isotropic displacement parameters
of Li₄PS₄I obtained from single-crystal X-ray diffraction at 280K.

| | Wyckoff | | | | | |
|---|---|---|---|---|---|---|
| Atom | site | x | y | z | SOF | U(eq) (Å²) |
| P | 4f | ¾ | ¼ | 0.23808(5) | 1 | 0.01285(13) |
| S1 | 8i | ¼ | 0.55085(5) | 0.85705(4) | 1 | 0.01798(11) |
| S2 | 8i | ¼ | 0.55964(5) | 0.34542(4) | 1 | 0.01769(11) |
| I1 | 2c | ¼ | ¼ | 0.07640(2) | 1 | 0.02508(9) |
| I2 | 2c | ¼ | ¼ | 0.57613(2) | 1 | 0.02168(9) |
| Li1 | 2c | ¼ | ¼ | 0.3040(7) | 1 | 0.0339(18) |
| Li2 | 2b | ¾ | ¼ | ½ | 1 | 0.0314(16) |
| Li3 | 8j | 0.0457(3) | 0.0457(3) | 0.7120(3) | 1 | 0.0319(8) |
| Li4 | 4d | 0 | 0 | 0 | 1 | 0.0546(17) |

TABLE 11
Anisotropic displacement parameters (Å2) of Li₄PS₄I
from single-crystal X-ray diffraction at 280K.

| Atom | ^{U}11 | ^{U}22 | ^{U}33 | ^{U}23 | ^{U}13 | ^{U}12 |
|---|---|---|---|---|---|---|
| P | 0.0132(3) | 0.0109(3) | 0.0144(3) | 0 | 0 | 0 |
| S1 | 0.0211(2) | 0.0135(2) | 0.0194(2) | 0.00319(16) | 0 | 0 |
| S2 | 0.0206(2) | 0.0130(2) | 0.0194(2) | 0.00201(16) | 0 | 0 |
| I1 | 0.02903(12) | 0.02903(12) | 0.01718(14) | 0 | 0 | 0 |
| I2 | 0.02382(11) | 0.02382(11) | 0.01741(14) | 0 | 0 | 0 |
| Li1 | 0.038(3) | 0.038(3) | 0.026(4) | 0 | 0 | 0 |
| LI2 | 0.038(3) | 0.038(3) | 0.018(3) | 0 | 0 | 0 |
| Li3 | 0.0275(11) | 0.0275(11) | 0.041(2) | −0.0013(12) | −0.0013(12) | 0.0071(15) |
| Li4 | 0.059(3) | 0.059(3) | 0.046(3) | 0.008(2) | 0.008(2) | −0.009(4) |

TABLE 12
Bond distances in Li₄PS₄I obtained from single-
crystal X-ray diffraction at 280 K.

| Atom1 | Atom2 | Bond Distance (Å) |
|---|---|---|
| P | S1 | 2.0302(6) × 2 |
| P | S2 | 2.0549(6) × 2 |
| Li1 | S2 | 2.6708(15) × 4 |
| Li1 | I1 | 2.697(8) |
| Li1 | I2 | 3.224(8) |
| Li2 | S2 | 2.4414(5) × 4 |
| Li3 | S1 | 2.574(3) × 2 |
| Li3 | S2 | 2.601(3) × 2 |
| Li3 | I2 | 2.932(4) |
| Li4 | S1 | 2.7475(3) × 4 |
| Li4 | I1 | 3.13147(15) |
| Li3 | Li3 | 3.464(6) |
| Li3 | Li4 | 3.456(4) |

TABLE 13
Atomic coordinates, occupation fraction and isotropic displacement parameters
of Li_{4.3}P_{0.7}Si_{0.3}S₄I obtained from time-of-flight neutron diffraction
at 300K. After the scale factor, Chebyshev background, peak shape, lattice
parameters, atomic positions were refined, the Li, S, P, and Si SOFs
were refined - obtaining the SOFs shown in the table. The unknown Bragg
reflection at 4.05 Å was excluded from the refinement.

| | Wyckoff | | | | | |
|---|---|---|---|---|---|---|
| Atom | site | x | y | z | SOF | U(eq) (Å²) |
| P | 2b | ¾ | ¼ | ½ | 0.719(59) | 0.01747(6) |
| Si | 2b | ¾ | ¼ | ½ | 0.281(59) | 0.01747(6) |
| S | 8i | ¼ | 0.5554(4) | 0.7049(6) | 1 | 0.02710(8) |
| I | 2c | ¼ | ¼ | 0.1562(6) | 1 | 0.0316(10) |
| Li1 | 2c | ¼ | ¼ | 0.617(4) | 0.50(7) | 0.03292(6) |
| Li2 | 2a | ¾ | ¼ | 0 | 0.57(3) | 0.03039(6) |
| Li3 | 8j | 0.0394(10) | 0.0394(10) | 0.4227(17) | 0.567(12) | 0.04052(3) |
| Li4 | 4d | 0 | 0 | 0 | 0.49(2) | 0.0620(8) |

TABLE 14
Atomic coordinates, occupation fraction and isotropic displacement parameters
of Li₄PS₄I obtained from time-of-flight neutron diffraction at 300K.

| | Wyckoff | | | | | |
|---|---|---|---|---|---|---|
| Atom | site | x | y | z | SOF | U(eq) (Å²) |
| P | 4f | ¾ | ¼ | 0.23778(16) | 1 | 0.011627(43) |
| S1 | 8i | ¼ | 0.55085(5) | 0.85805(20) | 1 | 0.01728(65) |
| S2 | 8i | ¼ | 0.55964(5) | 0.34545(21) | 1 | 0.016942(60) |
| I1 | 2c | ¼ | ¼ | 0.07594(2) | 1 | 0.02245(8) |
| I2 | 2c | ¼ | ¼ | 0.57629(2) | 1 | 0.02112(8) |
| Li1 | 2c | ¼ | ¼ | 0.30588(35) | 1 | 0.02994(10) |
| Li2 | 2b | ¾ | ¼ | ½ | 1 | 0.02482(18) |
| Li3 | 8j | 0.0423 (3) | 0.0423(3) | 0.7144(3) | 1 | 0.03774(2) |
| Li4 | 4d | 0 | 0 | 0 | 1 | 0.04952(16) |

TABLE 15
Atomic coordinates, occupation fraction and isotropic displacement parameters
of Li₄PS₄I obtained from time-of-flight neutron diffraction at 300K. After the
scale factor, Chebyshev background, peak shape, lattice parameters, atomic
positions were refined, the Li, S, and P SOFs were refined - obtaining the SOFs
shown in the table- giving a composition of Li_{3.81(28)}PS₄I. Lattice parameters a = b =
8.46497(11) Å, c = 11.83459(19) Å, V = 848.016(26) Å3. Initially, the four Li sites were
freely refined, Li(1) and Li(4) sites refined to slightly above 1, and were then constrained
to a maximum SOF of 1 before performing the final refinement shown below.

| | Wyckoff | | | | | |
|---|---|---|---|---|---|---|
| Atom | site | x | y | z | SOF | U(eq) (Å²) |
| P | 4f | ¾ | ¼ | 0.23774(15) | 1 | 0.01905(31) |
| S1 | 8i | ¼ | 0.55211(37) | 0.85785(20) | 1 | 0.01366(50) |
| S2 | 8i | ¼ | 0.55884(34) | 0.34545(21) | 1 | 0.013042(16) |
| I1 | 2c | ¼ | ¼ | 0.07594(2) | 1 | 0.02245(8) |
| I2 | 2c | ¼ | ¼ | 0.57629(2) | 1 | 0.02112(8) |
| Li1 | 2c | ¼ | ¼ | 0.30588(35) | 1.000(13) | 0.02324(10) |
| LI2 | 2b | ¾ | ¼ | ½ | 0.877(24) | 0.02265(18) |
| Li3 | 8j | 0.04394(34) | 0.04394(34) | 0.71236(3) | 0.935(27) | 0.02592(27) |
| Li4 | 4d | 0 | 0 | 0 | 1.000(21) | 0.03721(19) |

TABLE 16
Atomic coordinates, occupation fraction and isotropic displacement
parameters of Li₄PS₄I obtained from time-of-flight neutron diffraction
at 300K using the “disordered” model obtained from the
Si-substituted counterpart. The SOFs and atomic displacement
parameters of the four lithium sites were refined, indicating a
lithium content of Li = 3.05(37). Lattice parameters a = b =
8.48163(20) Å, c = 5.92894(16) Å, V = 426.517(23) Å3.

| | Wyckoff | | | | | |
|---|---|---|---|---|---|---|
| Atom | site | x | y | z | SOF | U(eq) (Å²) |
| P | 2b | ¾ | ¼ | ½ | 1 | 0.01617(7) |
| S | 8i | ¼ | 0.55604 | 0.70375 | 1 | 0.01780(6) |
| I | 2c | ¼ | ¼ | 0.1525 | 1 | 0.01975(8) |
| Li1 | 2c | ¼ | ¼ | 0.61885 | 0.437(2) | 0.00240(3) |
| Li2 | 2a | ¾ | ¼ | 0 | 0.485(3) | 0.05066(8) |
| Li3 | 8j | 0.0461 | 0.0461 | 0.4225 | 0.2744(7) | 0.02938(2) |
| Li4 | 4d | 0 | 0 | 0 | 0.515(2) | 0.07003(4) |

TABLE 17
Atomic coordinates, occupation fraction and isotropic displacement parameters
of Li_{4.3}P_{0.7}Si_{0.3}S₄I obtained from time-of-flight neutron diffraction at 300K using the
reported model for Li4PS4I (P4/nmm; Z = 2). The SOFs and atomic displacement
parameters of the five lithium sites were refined, indicating a lithium content
of Li = 3.68(39). Lattice parameters a = b = 8.4883(24) Å, c = 5.9407(17) Å,
V = 428.04(28) Å3. A negative isotropic thermal parameter of the Li1 site was
obtained. The isotropic thermal parameter and occupancy of the Li2 site refined to zero.

| | Wyckoff | | | | | |
|---|---|---|---|---|---|---|
| Atom | site | x | y | z | SOF | U(eq) (Å²) |
| P | 2b | ¾ | ¼ | 0.1232(84) | 0.7 | 0.03356(93) |
| Si | 2b | ¾ | ¼ | 0.1232(84) | 0.3 | 0.03356(93) |
| S | 8i | ¼ | 0.9412(09) | 0.2926(12) | 1 | 0.03546(2) |
| I | 2c | ¾ | ¾ | 0.1529(12) | 1 | 0.02698(32) |
| Li1 | 2c | ¾ | ¾ | 0.667(15) | 0.273(81) | — |
| LI2 | 2a | ¼ | ¾ | 0 | 0 | — |
| Li3 | 8j | 0.4759(14) | 0.4759(14) | 0.5934(26) | 0.581(34) | 0.00937(52) |
| Li4 | 4d | 0 | 0 | 0 | 1 | 0.00535(89) |
| Li5 | 8i | ¾ | 0.2321(82) | 0.132(22) | 0.69(14) | 0.06333(44) |

TABLE 18
Atomic coordinates, occupation fraction and isotropic displacement parameters
of Li_{4.3}P_{0.7}Si_{0.3}S₄I obtained from time-of-flight neutron diffraction at 300K using the
ordered model obtained from single crystal X-ray diffraction for Li₄PS₄I. The
obtained Li-ion content, Li_{3.81(3)}P_{0.7}Si_{0.3}S₄I, is lower than the targeted value.
Parameters: a = b = 8.5088(7) Å, c = 11.8945(10) Å, V = 861.16(16) Å³, Z = 4.

| | Wyckoff | | | | | |
|---|---|---|---|---|---|---|
| Atom | site | x | y | z | SOF | U(eq) (Å²) |
| P | 4f | ¾ | ¼ | 0.24020(12) | 0.71 | 0.0133(3) |
| Si | 4f | ¾ | ¼ | 0.24020(12) | 0.29 | 0.0133(3) |
| S1 | 8i | ¼ | 0.55159(16) | 0.85665(8) | 1 | 0.0201(3) |
| S2 | 8i | ¼ | 0.55896(16) | 0.34692(7) | 1 | 0.0191(3) |
| I1 | 2c | ¼ | ¼ | 0.07828(5) | 1 | 0.0300(2) |
| I2 | 2c | ¼ | ¼ | 0.57944(4) | 1 | 0.02362(19) |
| Li1 | 8j | 0.0432(8) | 0.0432(8) | 0.7109(7) | 1 | 0.036(2) |
| LI2 | 4d | 0 | 0 | 0 | 0.75(3) | 0.042(6) |
| Li3 | 2c | ¼ | ¼ | 0.3075(14) | 1 | 0.036(4) |
| Li4 | 2b | ¾ | ¼ | ½ | 1 | 0.033(5) |
| Li5 | 2a | ¾ | ¼ | 0 | 0.11(5) | 0.01(4) |

TABLE 19
Fitted EIS parameters for Li₄₊ₓP₁₋ₓSiₓS₄I,
x = 0, 0.12, 0.30, 0.40 at room temperature.

| Compound | CPE1 (F · s^{(a-1)}) | a1 | CPE2 (F · s^{(a-1)}) | a2 | R2(Ω) |
|---|---|---|---|---|---|
| Li₄PS₄I | 1.158E−9 | 0.915 | 8.407E−6 | 0.830 | 3,108 |
| Li_{4.12}P_{0.88}Si_{0.12}S₄I | 9.170E−10 | 0.928 | 4.833E−6 | 0.794 | 197.8 |
| Li_{4.3}P_{0.7}Si_{0.3}S₄I | 1.68E−9 | 0.884 | 1.09E−5 | 0.797 | 147.8 |
| Li_{4.4}P_{0.6}Si_{0.4}S₄I | 1.84E−9 | 0.898 | 7.768E−6 | 0.784 | 379 |

TABLE 20
Room temperature ionic conductivity values for Li₄₊ₓP₁₋ₓSiₓS₄I,
x = 0, 0.12, 0.30, 0.40 obtained by fitting of the EIS spectra of the
pellets pressed at 2 metric tons. The diameter of the pressed pellets was 1.0 cm.

| | x = 0 | x = 0.12 | x = 0.30 | x = 0.40 |
|---|---|---|---|---|
| Thickness (mm) | 1.01 | 0.77 | 1.02 | 0.94 |
| R (Ω) | 3108 | 197.8 | 107 | 379 |
| Total σ (m S · cm⁻¹) | 0.041 | 0.5 | 1.21 | 0.32 |
| Thickness (mm) | 0.6 | 0.911 | 1.48 | 0.6 |
| R (Ω) | 1910 | 204 | 147.8 | 170.2 |
| Total σ (mS · cm⁻¹) | 0.039 | 0.56 | 1.27 | 0.45 |
| Thickness (mm) | 0.75 | | 0.4 | |
| R (Ω) | 200 | | 35 | |
| Total σ (m S · cm⁻¹) | 0.048 | | 1.50 | |
| Thickness (mm) | 0.95 | | 1.2 | |
| R (Ω) | 2193 | | 92.5 | |
| Total σ (m S · cm⁻¹) | 0.055 | | 1.65 | |
| Thickness (mm) | | | 1.8 | |
| R (Ω) | | | 136.6 | |
| Total σ (m S · cm⁻¹) | | | 1.67 | |
| Average σ (10⁻⁴ S · cm⁻¹) | 0.46 | 0.53 | 1.46 | 0.385 |
| S.D | 0.06 | 0.03 | 0.2 | 0.07 |

### REFERENCES

[1] Janek, J.; Zeier, W. G. A Solid Future for Battery Development. Nature Energy 2016, 1 (9), 16141.
[2] Zaman, W.; Hatzell, K. B. Processing and Manufacturing of next Generation Lithium-Based All Solid-State Batteries. Curr. Opin. Solid State Mater. Sci 2022, 26 (4), 101003.
[3] Chen, R.; Li, Q.; Yu, X.; Chen, L.; Li, H. Approaching Practically Accessible Solid-State Batteries: Stability Issues Related to Solid Electrolytes and Interfaces. Chem. Rev. 2020, 120 (14), 6820-6877.
[4] Manthiram, A.; Yu, X.; Wang, S. Lithium Battery Chemistries Enabled by Solid-State Electrolytes. Nat. Rev. Mater. 2017, 2 (4), 16103.
[5] Liu, Q.; Jiang, L.; Zheng, P.; Sun, J.; Liu, C.; Chai, J.; Li, X.; Zheng, Y.; Liu, Z. Recent Advances in Stability Issues of Inorganic Solid Electrolytes and Composite Solid Electrolytes for All-Solid-State Batteries. Chem. Rec. 2022, e202200116, 1-23.
[6] Sun, Y.-K. Promising All-Solid-State Batteries for Future Electric Vehicles. ACS Energy Lett. 2020, 5 (10), 3221-3223.
[7] Lee, J.; Choi, S. H.; Im, G.; Lee, K.-J.; Lee, T.; Oh, J.; Lee, N.; Kim, H.; Kim, Y.; Lee, S.; Choi, J. W. Room-Temperature Anode-Less All-Solid-State Batteries via the Conversion Reaction of Metal Fluorides. Adv. Mater. 2022, 2203580, 2-5.
[8] Schlem, R.; Burmeister, C. F.; Michalowski, P.; Ohno, S.; Dewald, G. F.; Kwade, A.; Zeier, W. G. Energy Storage Materials for Solid-State Batteries: Design by Mechanochemistry. Adv. Energy Mater. 2021, 11 (30), 2101022.
[9] Hayashi, A.; Minami, K.; Ujiie, S.; Tatsumisago, M. Preparation and Ionic Conductivity of Li7P3S11—z Glass-Ceramic Electrolytes. J. Non-Cryst. Solids 2010, 356 (44-49), 2670-2673.
[10] Deysher, G.; Ridley, P.; Ham, S.-Y.; Doux, J.-M.; Chen, Y.-T.; Wu, E. A.; Tan, D. H. S.; Cronk, A.; Jang, J.; Meng, Y. S. Transport and Mechanical Aspects of All-Solid-State Lithium Batteries. Mater. Today Phys. 2022, 24, 100679.
[11] Kwak, H.; Wang, S.; Park, J.; Liu, Y.; Kim, K. T.; Choi, Y.; Mo, Y.; Jung, Y. S. Emerging Halide Superionic Conductors for All-Solid-State Batteries: Design, Synthesis, and Practical Applications. ACS Energy Lett. 2022, 7 (5), 1776-1805.
[12] Zhou, L.; Minafra, N.; Zeier, W. G.; Nazar, L. F. Innovative Approaches to Li-Argyrodite Solid Electrolytes for All-Solid-State Lithium Batteries. Acc. Chem. Res. 2021, 54 (12), 2717-2728.
[13] Zhou, L.; Zuo, T.-T.; Kwok, C. Y.; Kim, S. Y.; Assoud, A.; Zhang, Q.; Janek, J.; Nazar, L. F. High Areal Capacity, Long Cycle Life 4 V Ceramic All-Solid-State Li-Ion Batteries Enabled by Chloride Solid Electrolytes. Nat. Energy 2022, 7 (1), 83-93.
[14] Randau, S.; Weber, D. A.; Kötz, O.; Koerver, R.; Braun, P.; Weber, A.; Ivers-Tiffee, E.; Adermann, T.; Kulisch, J.; Zeier, W. G.; Richter, F. H.; Janek, J. Benchmarking the Performance of All-Solid-State Lithium Batteries. Nat. Energy 2020, 5 (3), 259-270.

[15] Ohno, S.; Banik, A.; Dewald, G. F.; Kraft, M. A.; Krauskopf, T.; Minafra, N.; Till, P.; Weiss, M.; Zeier, W. G. Materials Design of Ionic Conductors for Solid State Batteries. Prog. Energy 2020, 2 (2), 022001.
[16] Mizuno, F.; Hayashi, A.; Tadanaga, K.; Tatsumisago, M. New, Highly Ion-Conductive Crystals Precipitated from Li2S—P2S5 Glasses. Adv. Mater. 2005, 17 (7), 918-921.
[17] Cai, Y.; Li, C.; Zhao, Z.; Mu, D.; Wu, B. Air Stability and Interfacial Compatibility of Sulfide Solid Electrolytes for Solid-State Lithium Batteries: Advances and Perspectives. ChemElectroChem 2022, 9 (5), e202101479.
[18] Kraft, M. A.; Culver, S. P.; Calderon, M.; Bocher, F.; Krauskopf, T.; Senyshyn, A.; Dietrich, C.; Zevalkink, A.; Janek, J.; Zeier, W. G. Influence of Lattice Polarizability on the Ionic Conductivity in the Lithium Superionic Argyrodites Li6PS5X (X=Cl, Br, I). J. Am. Chem. Soc. 2017, 139 (31), 10909-10918.
[19] Tatsumisago, M.; Nagao, M.; Hayashi, A. Recent Development of Sulfide Solid Electrolytes and Interfacial Modification for All-Solid-State Rechargeable Lithium Batteries. J. Asian Ceram. Soc. 2013, 1 (1), 17-25.
[20] Ohtomo, T.; Hayashi, A.; Tatsumisago, M.; Tsuchida, Y.; Hama, S.; Kawamoto, K. All-Solid-State Lithium Secondary Batteries Using the 75Li2S.25P2S5 Glass and the 70Li2S.30P2S5 Glass-Ceramic as Solid Electrolytes. Journal of Power Sources 2013, 233, 231-235.
[21] Takada, K. Progress in Solid Electrolytes toward Realizing Solid-State Lithium Batteries. J. Power Sources 2018, 394, 74-85.
[22] Wood, M.; Gao, X.; Shi, R.; Heo, T. W.; Espitia, J. A.; Duoss, E. B.; Wood, B. C.; Ye, J. Exploring the Relationship between Solvent-Assisted Ball Milling, Particle Size, and Sintering Temperature in Garnet-Type Solid Electrolytes. J. Power Sources 2021, 484, 229252.
[23] Kamaya, N.; Homma, K.; Yamakawa, Y.; Hirayama, M.; Kanno, R.; Yonemura, M.; Kamiyama, T.; Kato, Y.; Hama, S.; Kawamoto, K.; Mitsui, A. A Lithium Superionic Conductor. Nat. Mater. 2011, 10 (9), 682-686.
[24] Bron, P.; Johansson, S.; Zick, K.; Schmedt auf der Günne, J.; Dehnen, S.; Roling, B. Li10SnP2S12: An Affordable Lithium Superionic Conductor. J. Am. Chem. Soc. 2013, (42), 15694-15697.
[25] Kuhn, A.; Gerbig, O.; Zhu, C.; Falkenberg, F.; Maier, J.; Lotsch, B. V. A New Ultrafast Superionic Li-Conductor: Ion Dynamics in Li11Si2PS12 and Comparison with Other Tetragonal LGPS-Type Electrolytes. Phys. Chem. Chem. Phys. 2014, 16 (28), 14669-14674.
[26] Kato, Y.; Hori, S.; Saito, T.; Suzuki, K.; Hirayama, M.; Mitsui, A.; Yonemura, M.; Iba, H.; Kanno, R. High-Power All-Solid-State Batteries Using Sulfide Superionic Conductors. 21 Nature Energy 2016, 1 (4), 16030.
[27] Deiseroth, H.-J.; Kong, S.-T.; Eckert, H.; Vannahme, J.; Reiner, C.; Zaiß, T.; 23 Schlosser, M. Li6PS5X: A Class of Crystalline Li-Rich Solids With an Unusually High Li+ Mobility. Angew. Chem. Int. Ed. 2008, 47 (4), 755-758.
[28] Yu, C.; Ganapathy, S.; Eck, E. R. H. van; Wang, H.; Basak, S.; Li, Z.; Wagemaker, M. Accessing the Bottleneck in All-Solid State Batteries, Lithium-Ion Transport over the Solid-Electrolyte-Electrode Interface. Nat. Commun. 2017, 8 (1), 1086.
[29] Zhou, L.; Assoud, A.; Zhang, Q.; Wu, X.; Nazar, L. F. New Family of Argyrodite Thioantimonate Lithium Superionic Conductors. J. Am. Chem. Soc. 2019, 141 (48), 19002-2 19013.
[30] Kraft, M. A.; Ohno, S.; Zinkevich, T.; Koerver, R.; Culver, S. P.; Fuchs, T.; Senyshyn, A.; Indris, S.; Morgan, B. J.; Zeier, W. G. Inducing High Ionic Conductivity in the Lithium Superionic Argyrodites Li6+xP1-XGexS51 for All-Solid-State Batteries. J. Am. Chem. Soc. 2018, 140 (47), 16330-16339.
[31] Kanno, R.; Murayama, M. Lithium Ionic Conductor Thio-LISICON: The Li₂S-GeS2-P2S5 System. J. Electrochem. Soc. 2001, 148 (7), A742-A746.
[32] Deng, Y.; Eames, C.; Chotard, J.-N.; Lalère, F.; Seznec, V.; Emge, S.; Pecher, O.; Grey, C. P.; Masquelier, C.; Islam, M. S. Structural and Mechanistic Insights into Fast Lithium-Ion Conduction in Li4SiO4-Li3PO4 Solid Electrolytes. J. Am. Chem. Soc. 2015, 137 (28), 9136-9145.
[33] Tao, B.; Ren, C.; Li, H.; Liu, B.; Jia, X.; Dong, X.; Zhang, S.; Chang, H. Thio-/LISICON and LGPS-Type Solid Electrolytes for All-Solid-State Lithium-Ion Batteries. Adv. Funct. Mater. 2022, 32 (34), 2203551.
[34] Yamane, H.; Shibata, M.; Shimane, Y.; Junke, T.; Seino, Y.; Adams, S.; Minami, K.; Hayashi, A.; Tatsumisago, M. Crystal Structure of a Superionic Conductor, Li7P3S11. Solid State Ion. 2007, 178 (15-18), 1163-1167.
[35] Seino, Y.; Ota, T.; Takada, K.; Hayashi, A.; Tatsumisago, M. A Sulphide Lithium Super Ion Conductor Is Superior to Liquid Ion Conductors for Use in Rechargeable Batteries. Energy Environ. Sci. 2014, 7 (2), 627-631.
[36] Fahys, B.; Robert, G. Superionic conduction in Li2S—P2S5-LiI-glasses. Solid State Ion. 1981, 5, 663-666.
[37] Rangasamy, E.; Liu, Z.; Gobet, M.; Pilar, K.; Sahu, G.; Zhou, W.; Wu, H.; Greenbaum, S.; Liang, C. An Iodide-Based Li7P2S8I Superionic Conductor. J. Am. Chem. Soc. 2015, 137 (4), 1384-1387.
[38] Sedlmaier, S. J.; Indris, S.; Dietrich, C.; Yavuz, M.; Dräger, C.; von Seggern, F.; Sommer, H.; Janek, J. Li4PS4I: A Li+ Superionic Conductor Synthesized by a Solvent-Based 2 Soft Chemistry Approach. Chem. Mater. 2017, 29 (4), 1830-1835.
[39] Rajagopal, R.; Subramanian, Y.; Hwang, G.; Jung, Y. J.; Ryu, K.-S. Improved Ionic Conductivity and Structural Transition from (NLi2S—LiI)—(P2S5) Solid Solutions to LixP2Syl Crystalline Electrolytes. J. Alloys Compd. 2022, 900, 163435.
[40] Hikima, K.; Huy Phuc, N. H.; Matsuda, A. Synthesis of 3Li2S-1P2S5-XLiI Solid Electrolytes by Liquid-Phase Shaking Method for All-Solid-State Li Metal Batteries. J. Sol-Gel Sci. Technol. 2022, 101 (1), 16-23.
[41] Ujiie, S.; Hayashi, A.; Tatsumisago, M. Structure, Ionic Conductivity and Electrochemical Stability of Li2S—P2S5-LiI Glass and Glass-Ceramic Electrolytes. Solid State Ion. 2012, 211, 42-45.
[42] Rao, R. P.; Adams, S. Studies of Lithium Argyrodite Solid Electrolytes for All-Solid-State Batteries. Phys. Status Solidi A 2011, 208 (8), 1804-1807.
[43] Sicolo, S.; Kalcher, C.; Sedlmaier, S. J.; Janek, J.; Albe, K. Diffusion Mechanism in the Superionic Conductor Li4PS4I Studied by First-Principles Calculations. Solid State Ion. 16 2018, 319, 83-91.
[44] Strauss, F.; Lin, J.; Karger, L.; Weber, D.; Brezesinski, T. Probing the Lithium Substructure and Ionic Conductivity of the Solid Electrolyte Li4PS4I. Inorg. Chem. 2022, 61 (15), 5885-5890.
[45] Sheldrick, G. M. Crystal Structure Refinement with SHELXL. Acta Cryst. C 2015, 71 (1), 3-8.
[46] Chen, H.; Wong, L. L.; Adams, S. SoftBV—a Software Tool for Screening the Materials Genome of Inorganic Fast Ion Conductors. Acta Cryst. B 2019, 75 (1), 18-33.
[47] Chen, H.; Adams, S. Bond Softness Sensitive Bond-Valence Parameters for Crystal Structure Plausibility Tests. IUCrJ 2017, 4 (5), 614-625.
[48] Hohenberg, P.; Kohn, W. Inhomogeneous Electron Gas. Phys. Rev. 1964, 136 (3B), B864-B871.
[49] Kohn, W.; Sham, L. J. Self-Consistent Equations Including Exchange and Correlation Effects. Phys. Rev. 1965, 140 (4A), A1133-A1138.
[50] Kresse, G.; Furthmüller, J. Efficient Iterative Schemes for Ab Initio Total-Energy Calculations Using a Plane-Wave Basis Set. Phys. Rev. B 1996, 54 (16), 11169-11186.
[51] Perdew, J. P.; Burke, K.; Ernzerhof, M. Generalized Gradient Approximation Made Simple. Phys. Rev. Lett. 1996, 77 (18), 3865-3868.
[52] Blöchl, P. E. Projector Augmented-Wave Method. Phys. Rev. B 1994, 50 (24), 17953-17979.
[53] Kresse, G.; Joubert, D. From Ultrasoft Pseudopotentials to the Projector Augmented-Wave Method. Phys. Rev. B 1999, 59 (3), 1758-1775.
[54] Shuichi, N. Constant Temperature Molecular Dynamics Methods. Progress of Theoretical Physics Supplement 1991, 103, 1-46.
[55] van de Walle, A.; Asta, M.; Ceder, G. The Alloy Theoretic Automated Toolkit: A User Guide. Calphad 2002, 26 (4), 539-553.
[56] Zhou, P.; Wang, J.; Cheng, F.; Li, F.; Chen, J. A Solid Lithium Superionic Conductor Li11AlP2S12 with a Thio-LISICON Analogous Structure. Chem. Commun. 2016, 52 (36), 6091-6094.
[57] Aihara, Y.; Ito, S.; Omoda, R.; Yamada, T.; Fujiki, S.; Watanabe, T.; Park, Y.; Doo, S. The Electrochemical Characteristics and Applicability of an Amorphous Sulfide-Based Solid Ion Conductor for the Next-Generation Solid-State Lithium Secondary Batteries. Front. Energy Res. 2016, 4.
[58] Rayavarapu, P. R.; Sharma, N.; Peterson, V. K.; Adams, S. Variation in Structure and Li+-lon Migration in Argyrodite-Type Li6PS5X (X=Cl, Br, I) Solid Electrolytes. J. Solid State Electrochem. 2012, 16 (5), 1807-1813.
[59] Phani Dathar, G. K.; Balachandran, J.; Kent, P. R. C.; Rondinone, A. J.; Ganesh, P. Li-Ion Site Disorder Driven Superionic Conductivity in Solid Electrolytes: A First-Principles Investigation of β-Li3PS4. J. Mater. Chem. A 2017, 5 (3), 1153-1159.
[60] Xu, Z.; Chen, R.; Zhu, H. Li2CuPS4 Superionic Conductor: A New Sulfide-Based Solid-State Electrolyte. J. Mater. Chem. A 2019.
[61] Homma, K.; Yonemura, M.; Kobayashi, T.; Nagao, M.; Hirayama, M.; Kanno, R. Crystal Structure and Phase Transitions of the Lithium Ionic Conductor Li3PS4. Solid State Ion. 2011, 182 (1), 53-58.
[62] Kong, S. T.; Gün, Ö.; Koch, B.; Deiseroth, H. J.; Eckert, H.; Reiner, C. Structural Characterisation of the Li Argyrodites Li7PS6 and Li7PSe6 and Their Solid Solutions: Quantification of Site Preferences by MAS-NMR Spectroscopy. Eur. J. Chem. A 2010, 16 (17), 5138-5147.
[63] Song, Y. B.; Kim, D. H.; Kwak, H.; Han, D.; Kang, S.; Lee, J. H.; Bak, S.-M.; Nam, K.-W.; Lee, H.-W.; Jung, Y. S. Tailoring Solution-Processable Li Argyrodites Li6+xP1-XMxS5I (M=Ge, Sn) and Their Microstructural Evolution Revealed by Cryo-TEM for All-Solid-State Batteries. Nano Lett. 2020, 20 (6), 4337-4345.
[64] Hogrefe, K.; Minafra, N.; Hanghofer, I.; Banik, A.; Zeier, W. G.; Wilkening, H. M. R. Opening Diffusion Pathways through Site Disorder: The Interplay of Local Structure and Ion Dynamics in the Solid Electrolyte Li6+xP1-XGexS51 as Probed by Neutron Diffraction and NMR. J. Am. Chem. Soc. 2022, 144 (4), 1795-1812.
[65] Zhou, L.; Assoud, A.; Shyamsunder, A.; Huq, A.; Zhang, Q.; Hartmann, P.; Kulisch, J.; Nazar, L. F. An Entropically Stabilized Fast-lon Conductor: Li3.25[Si0.25P0.75]S4. Chem. Mater. 2019, 31 (19), 7801-7811.
[66] Sakuda, A., et al.; Mechanochemically Prepared Li2S—P2S5-LiBH4 Solid Electrolytes with an Argyrodite Structure. ACS Omega 2018, 3, 5453-5458.

1. A material having the formula Li₄₊ₓP₁₋ₓSiₓS₄Z for use as a solid electrolyte, where Z is a halide and/or a pseudohalide.

2. The material of claim 1, wherein Z is one or more of I⁻, Br⁻, [BH₄]⁻, [BF₄]⁻, [NH₂]⁻, and [N₃]⁻.

3. The material of claim 1, wherein Z is one or more of I—, Br—, and [BH4]-.

4. The material of claim 1, wherein Z is I—.

5. The material of claim 1, wherein 0.1<x<0.4.

6. The material of claim 1, wherein 0.12≤x≤0.3.

7. The material of claim 1, wherein x is 0.12 or 0.30.

8. The material of claim 1, wherein the material exhibits electrical conductivity greater than 0.046 mS·cm⁻¹ and an activation energy less than 0.44 eV at room temperature.

9. The material of claim 1, wherein the material exhibits electrical conductivity of at least 1.46 mS·cm⁻¹ and an activation of less than 0.32 eV at room temperature.

10. A method of producing a material for use as a solid electrolyte, the material having the formula Li₄₊ₓP₁₋ₓSiₓS₄Z, where Z is a halide and/or a pseudohalide, the method comprising the steps of:
a) forming a mixture by combining stoichiometric amounts of Li₂S, LiZ, P₂S₅, and Si powders;
b) grinding the mixture; and,
c) heating the ground mixture.

11. The method of claim 10, wherein Z is one or more of: I⁻, Br⁻, [BH₄]⁻, [BF₄]⁻, [NH₂]⁻, and [N₃]⁻.

12. The method of claim 10, wherein Z is one or more of I—, Br—, and [BH4]-.

13. The method of claim 10, wherein Z is I—.

14. The method of claim 10, wherein 0.1<x<0.4.

15. The method of claim 10, wherein 0.12≤x≤0.3.

16. The method of claim 10, wherein x is 0.12 or 0.30.

17. The method of claim 10, wherein step c) comprises heating the ground mixture to 700° C. with a heating rate of 60° C. per hour.

18. The method of claim 10, further comprising d) cooling the heated mixture.

19. The method of claim 18, wherein step d) comprises: i) cooling the mixture to 620-600° C. at a cooling rate of 1° C. per hour; and ii) ice quenching the mixture to room temperature.

20. A solid electrolyte comprising the material according to claim 1.

21. A solid-state battery, comprising:
a cathode,
an anode; and
a solid electrolyte, wherein the solid electrolyte comprises the material according to claim 1.
